(19) United States
(12) Patent Application Publication
(10) Pub. No.: US 2024/0062275 A1
(43) Pub. Date: Feb. 22, 2024

(54) SYSTEM, INFORMATION PROCESSING APPARATUS, METHOD, AND RECORDING MEDIUM

(71) Applicant: NEC Corporation, Minato-ku, Tokyo (JP)

(72) Inventors: Hideo Urai, Tokyo (JP); Tasuku Yoshihiro, Tokyo (JP); Sakie Morita, Tokyo (JP); Yuto Nakaya, Tokyo (JP); Kei Shibukawa, Tokyo (JP)

(73) Assignee: NEC Corporation, Minato-ku, Tokyo (JP)

(21) Appl. No.: 18/269,897

(22) PCT Filed: Feb. 5, 2021
(86) PCT No.: PCT/JP2021/004328

§ 371 Date: Jun. 27, 2023

(51) Int. Cl. G06Q 30/0601

(52) U.S. Cl. CPC G06Q 30/0639; G06Q 30/0633

(57) ABSTRACT

The system has an identification unit, an acquisition unit, a generation unit, and a display control unit. The identification unit identifies a customer. The acquisition unit acquires a shopping list including information on the product the identified customer is purchasing. The generation unit generates a route from a display device to the product included in the acquired shopping list, on the basis of the location of the product and the location of the display device. The display control unit displays the generated route on the display device.

### TECHNICAL FIELD

The present disclosure relates to a system and the like.

### BACKGROUND ART

There is a technique of guiding a customer in a store based on a shopping list created by the customer. For example, in the technique described in PTL 1, a processing device generates a recommended movement route from a list of products, and projects a movement direction onto a floor, a ceiling, a wall, or the like. For example, in the technique described in PTL 2, a robot guides the inside of a store according to a shopping list.

### CITATION LIST

### Patent Literature

PTL 1: WO 2019/116620 A1
PTL 2: JP 2008-003860 A

### SUMMARY OF INVENTION

### Technical Problem

In a store, it is difficult for a customer to search for a product from a shopping list. In the case of using PTL 1, a projection device needs to be separately installed. In the case of using PTL 2, a robot needs to be newly installed. In a case where a projection device or a robot is separately installed, there is a problem that it is expensive.

An example of an object of the present disclosure is to provide a system or the like that achieves cost reduction of guidance to a product on a shopping list for a customer.

### Solution to Problem

A system according to one aspect of the present disclosure includes: an identification means configured to identify a customer; an acquisition means configured to acquire a list including information on products to be purchased by the identified customer; a generation means configured to generate a route from a display device to the product based on a position of the product included in the acquired list and a position of the display device; and a display control means configured to display the generated route on the display device.

An information processing apparatus according to one aspect of the present disclosure includes: an identification means configured to identify a customer; an acquisition means configured to acquire a list including information on products to be purchased by the identified customer; a generation means configured to generate a route from a display device to the product based on a position of the product included in the acquired list and a position of the display device; and a display control means configured to display the generated route on the display device.

A method according to one aspect of the present disclosure includes: identifying a customer; acquiring a list including information on products to be purchased by the identified customer; generating a route from the display device to the product based on a position of the product included in the acquired list and a position of the display device; and displaying the generated route on the display device.

A non-transitory computer-readable recording medium according to an aspect of the present disclosure records a program for causing a computer to execute: identifying a customer; acquiring a list including information on products to be purchased by the identified customer; generating a route from the display device to the product based on a position of the product included in the acquired list and a position of the display device; and displaying the generated route on the display device.

### Advantageous Effects of Invention

According to the present disclosure, it is possible to reduce the cost of guiding a customer to a product on a shopping list.

### BRIEF DESCRIPTION OF DRAWINGS

FIG. 1 is a block diagram illustrating a configuration example of a system according to a first example embodiment.

FIG. 2 is a flowchart illustrating an operation example of the system according to the first example embodiment.

FIG. 3 is an explanatory diagram illustrating an example of a system according to a second example embodiment.

FIG. 4 is an explanatory diagram illustrating installation positions of digital signage in a store.

FIG. 5 is a block diagram illustrating a configuration example of the system according to the second example embodiment.

FIG. 6 is an explanatory diagram illustrating a storage example of a customer DB.

FIG. 7 is an explanatory diagram illustrating a storage example of a product DB.

FIG. 8 is an explanatory diagram illustrating an example of a shopping list.

FIG. 9 is an explanatory diagram illustrating an authentication example based on a face feature amount.

FIG. 10 is an explanatory diagram illustrating a display example of a route.

FIG. 11 is an explanatory diagram illustrating a display example of a plurality of routes.

FIG. 12 is an explanatory diagram illustrating an example of selecting a picked-up product.

FIG. 13 is an explanatory diagram illustrating a display example of a route after a product selected from a shopping list is deleted.

FIG. 14 is an explanatory diagram illustrating an addition example of a new product.

FIG. 15 is a flowchart (part 1) illustrating an operation example of the system according to the second example embodiment.

FIG. 16 is a flowchart (part 2) illustrating the operation example of the system according to the second example embodiment.

FIG. 17 is an explanatory diagram illustrating an example of a system according to a third example embodiment.

FIG. 18 is a block diagram illustrating a configuration example of a system according to the third example embodiment.

FIG. 19 is an explanatory diagram illustrating an example in which information on a checkout target product is deleted from a shopping list.

FIG. 20 is a flowchart illustrating an operation example of the system according to the third example embodiment.

FIG. 21 is an explanatory diagram illustrating a hardware configuration example of a computer device.

### EXAMPLE EMBODIMENT

Hereinafter, example embodiments of a system, an information processing apparatus, a method, a program, and a recording medium recording the program according to the present disclosure will be described in detail with reference to the drawings. However, the drawings schematically illustrate configurations in the example embodiments of the present disclosure. Further, the example embodiment of the present disclosure described below is an example, and can be appropriately changed within the scope of the same essence.

### First Example Embodiment

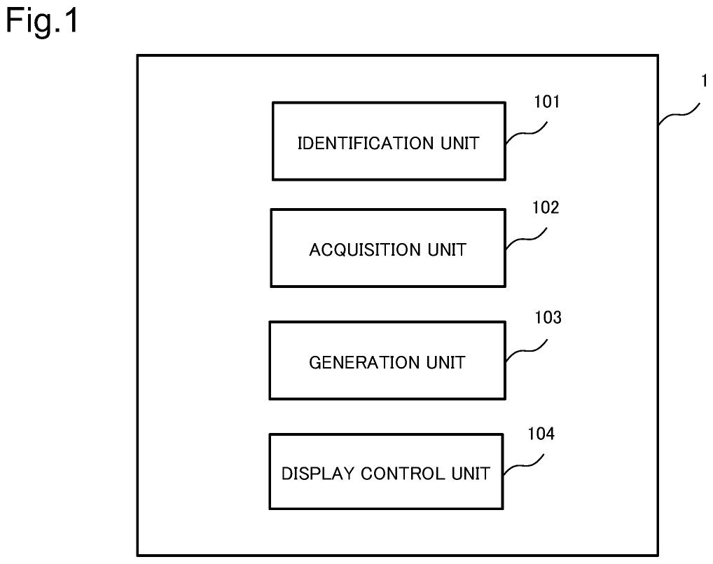

FIG. 1 is a block diagram illustrating a configuration example of a system according to a first example embodiment. A system 1 displays a route from the display device to a product included in the shopping list on the display device. The display device is, for example, a device installed in a store. The store is not particularly limited, and examples thereof include a supermarket, a super center, a drug store, and a home center. The product included in the shopping list is a product of which information is included in the shopping list. The type of the product is not particularly limited. For example, in the case of a supermarket, the product is food or the like. For example, in the case of a drug store, the product is a medicine, a product related to health, a product related to beauty, daily necessities, or the like. For example, in the case of a home center, the product is a daily necessities, a product related to home equipment, or the like. In FIG. 1, the system 1 includes an identification unit 101, an acquisition unit 102, a generation unit 103, and a display control unit 104.

The identification unit 101 identifies a customer. The identification method by the identification unit 101 is not particularly limited. Examples of the identification method include biometric authentication and authentication by inputting identification information of a customer. The biometric authentication is not particularly limited. Examples of the biometric authentication include face authentication, fingerprint authentication, vein authentication, iris authentication, and the like.

The acquisition unit 102 acquires a list including information on products that the identified customer is purchasing. This list is hereinafter referred to as a shopping list. Specifically, for example, the acquisition unit 102 may acquire the shopping list through a communication network or the like. Alternatively, for example, the acquisition unit 102 may acquire the shopping list by reading out the shopping list stored in a storage unit or the like. The acquisition unit 102 may acquire an input shopping list.

The generation unit 103 generates a route from a display device to the product included in the acquired shopping list, based on the location of the product and the location of the display device. The position of the display device may be stored in advance in a storage unit (not illustrated) or the like. Alternatively, the position of the display device may be specified by a device such as a beacon.

The display control unit 104 displays the generated route on the display device. Specifically, for example, the display control unit 104 may generate display information in which a route is added onto an image representing a map of the inside of the store, and display the route based on the display information on the display device. The display control unit 104 may display a part of the route on the display device. The display control unit 104 may display a screen including a route from the display device through all of the products included in the shopping list on the display device. As a result, the customer can confirm the entire route at a glance.

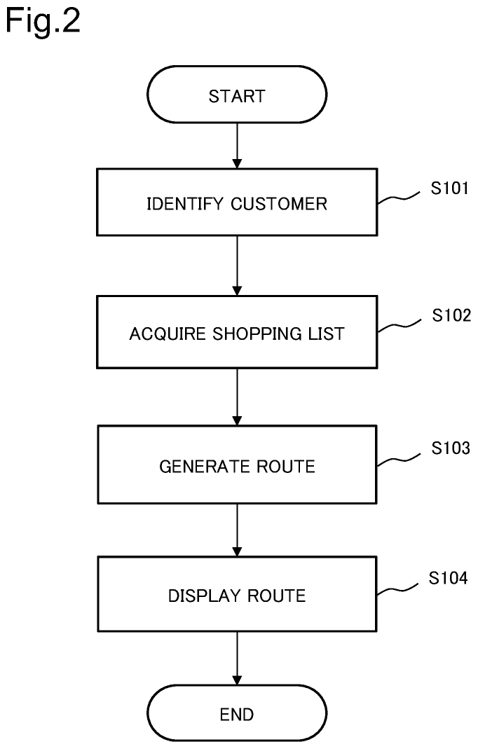

FIG. 2 is a flowchart illustrating an operation example of the system 1 according to the first example embodiment. The identification unit 101 identifies the customer (step S101). The acquisition unit 102 acquires the shopping list (step S102). Next, the generation unit 103 generates the route in the store based on the position of the product included in the acquired shopping list and the position of the display device (step S103). Then, the display control unit 104 displays the generated route on the display device (step S104). After step S104, the system 1 ends the operation of the flow.

Next, effects of the first example embodiment will be described. The system 1 generates a route in the store based on the position of the product included in the identified customer's shopping list and the position of the display device, and displays the route. The system 1 can reduce the cost of guiding a customer to a product on a shopping list.

For example, there is a high possibility that a special device such as a projection device or a robot is not present in a store. On the other hand, there is a high possibility that a display device is installed in a store. Therefore, the display device installed in the store can be effectively used. Therefore, even if the customer does not have a terminal device such as a smartphone or a map of a physical store, it is possible to easily find a product on the shopping list.

The first example embodiment is not limited to the example described above, and various modifications can be made. For example, each functional unit may be achieved by one device (information processing apparatus). Alternatively, each functional unit may be implemented by a plurality of devices.

### Second Example Embodiment

Hereinafter, a second example embodiment will be described in detail with reference to the drawings. In the second example embodiment, an example in which a functional unit of the system 1 described in the first example embodiment is used as a basic configuration and digital signage is used as a display device will be described. In the second example embodiment, the face authentication is described as an example of the customer identification method. Hereinafter, description of contents overlapping with the above description will be omitted to the extent that the description of the second example embodiment is not unclear.

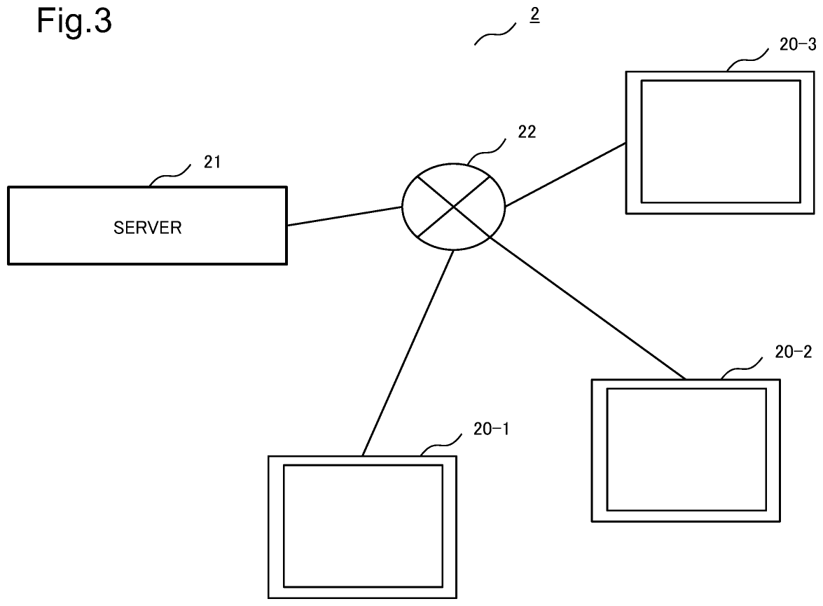

FIG. 3 is an explanatory diagram illustrating an example of a system according to the second example embodiment. A system 2 includes a plurality of digital signages 20-1 to 20-3 and a server 21. The server 21 and the plurality of digital signages 20-1 to 20-3 are connected via a communication network 22. The plurality of digital signages 20-1 to 20-3 are installed in a store. As described in the first example embodiment, the store is not particularly limited. In the second example embodiment, a supermarket is taken as an example of a store, and food is taken as an example of a product, but the store and the product are not particularly limited. In the example of FIG. 3, the number of digital signages 20 is 3, but is not particularly limited.

The server 21 is a device (information processing apparatus) that generates a route to a product on a shopping list. Each of the plurality of digital signages 20-1 to 20-3 has a display device such as a touch panel display or a display. Each of the plurality of digital signages 20-1 to 20-3 guides the customer to a route from its own device (digital signage 20) to a product on the shopping list.

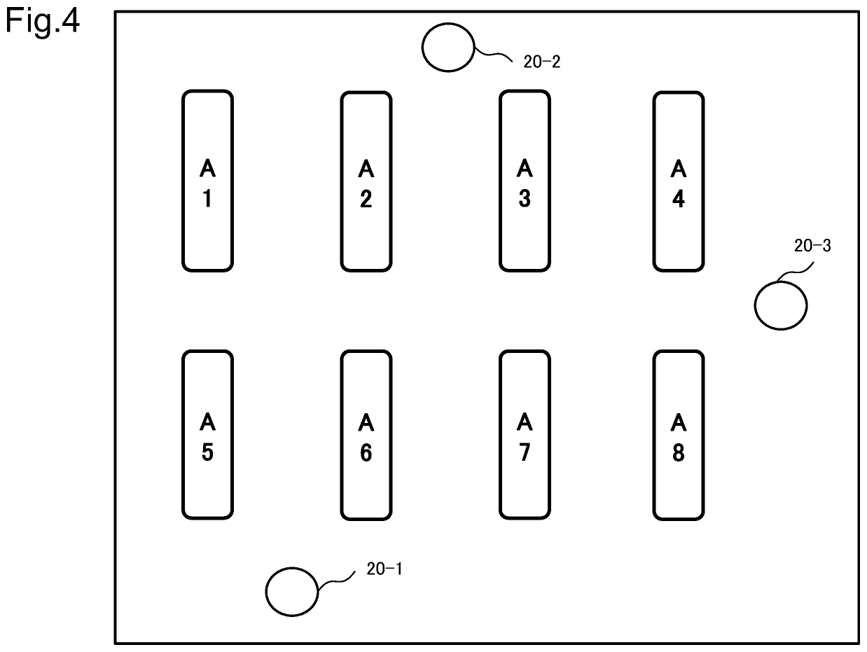

FIG. 4 is an explanatory diagram illustrating an installation position of the digital signage 20 in a store. In the store, for example, a plurality of shelves (A1 to A8) and a plurality of digital signages 20-1 to 20-3 are installed. The digital signage 20-1 is installed near the shelf A5 and the shelf A6. The digital signage 20-2 is installed near the shelf A2 and the shelf A3. The digital signage 20-3 is installed near the shelf A4 and the shelf A8. The store may be a store having a plurality of floors. One or more digital signage 20 may be installed on each floor.

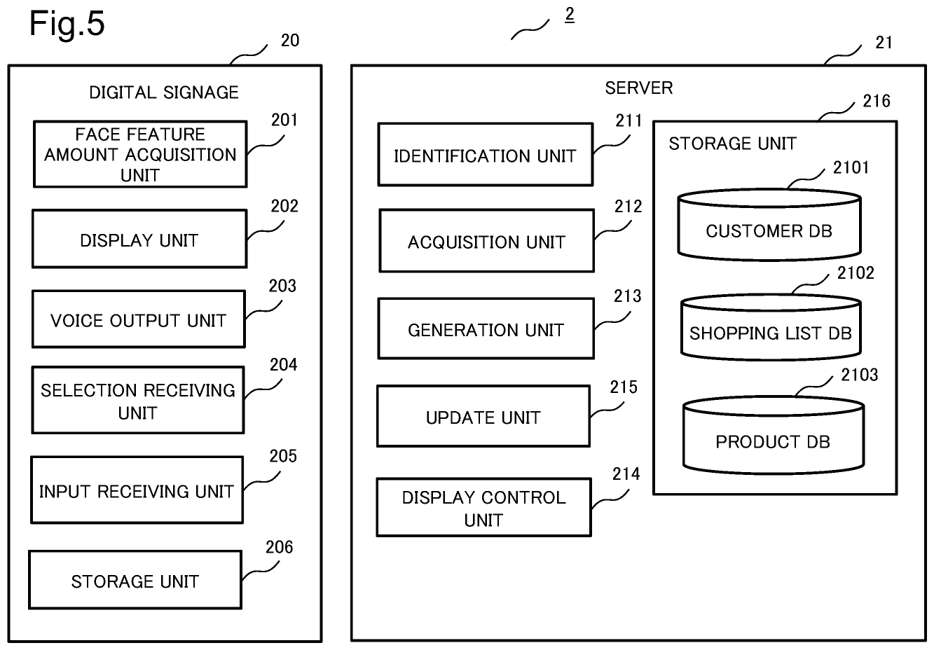

FIG. 5 is a block diagram illustrating a configuration example of a system 2 according to the second example embodiment. The system 2 includes a digital signage 20 and a server 21. The digital signage 20 includes a face feature amount acquisition unit 201, a display unit 202, a voice output unit 203, a selection receiving unit 204, an input receiving unit 205, and a storage unit 206. The digital signage 20 may not have some of the functional units. Alternatively, the digital signage 20 may have a functional unit (not illustrated).

The storage unit 206 stores, for example, a processing result of each unit of the digital signage 20. The storage unit 206 is a read only memory (ROM), a random access memory (RAM), a semiconductor memory, a hard disk drive (HDD), a solid state drive (SSD), or the like. The storage unit 206 may be a combination thereof.

The server 21 includes an identification unit 211, an acquisition unit 212, a generation unit 213, an update unit 215, a display control unit 214, and a storage unit 216. The identification unit 211 has the function of the identification unit 101 described in the first example embodiment as a basic function. The acquisition unit 212 has the function of the acquisition unit 102 according to the first example embodiment as a basic function. The generation unit 213 has the function of the generation unit 103 described in the first example embodiment as a basic function. The display control unit 214 has the function of the display control unit 104 described in the first example embodiment as a basic function. The server 21 may not have some of the functional units. Alternatively, the server 21 may include a functional unit (not illustrated).

The storage unit 216 stores, for example, a processing result of each unit of the server 21. Examples of the storage unit 216 include a ROM, a RAM, a semiconductor memory, an HDD, and an SSD. The storage unit 216 may be a combination thereof. In FIG. 5, the storage unit 216 includes a customer DB 2101, shopping list DB 2102, and product DB 2103. The storage unit 216 may have map information of a store separately from the position information for each product.

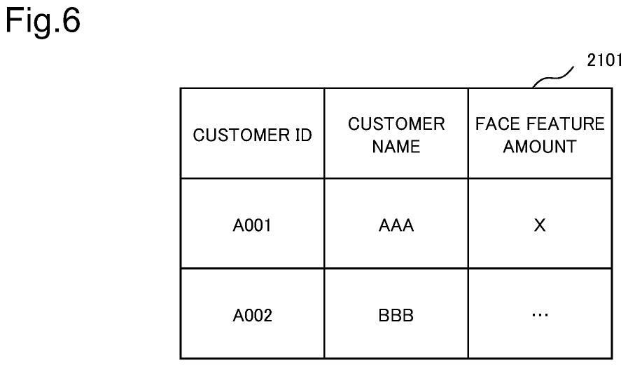

FIG. 6 is an explanatory diagram illustrating a storage example of the customer DB 2101. The customer DB 2101 stores the face feature amount for each customer. In FIG. 6, the customer DB 2101 stores, for example, information such as a customer ID, a customer name, and a face feature amount for each customer. The customer ID is an identifier that can uniquely identify the customer. The customer ID is not particularly limited. The customer ID may be, for example, a customer name, a contact address of a customer, or the like. The customer name is a full name, a name, or the like of the customer.

The face feature amount is, for example, one or a plurality of facial feature points. The format of the information of the face feature amount is not particularly limited. The face feature amount is obtained, for example, by extracting a facial feature point or the like from a face image. The technology for extracting the face feature amount is not particularly limited. For example, an existing technology may be used as the technology for extracting the face feature amount. The face feature amount is used for face authentication. In a case where a face image is used instead of the face feature amount in the face authentication, the customer DB 2101 may store the face image instead of the face feature amount.

The customer DB 2101 may not include a part of the illustrated contents. The customer DB 2101 may include contents other than those illustrated.

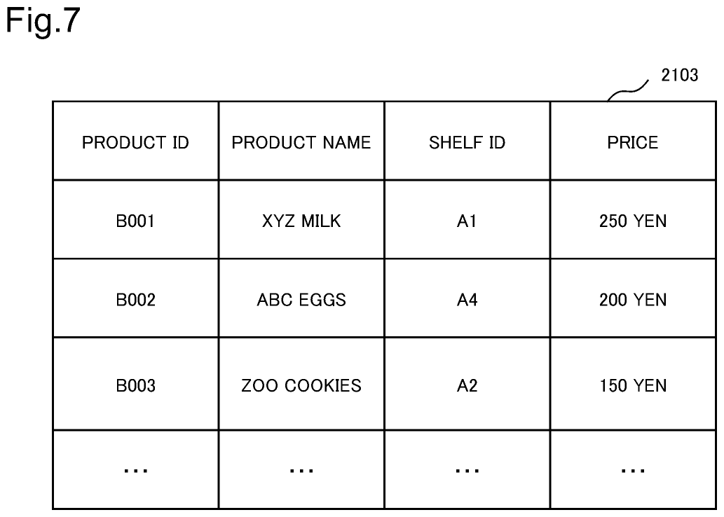

FIG. 7 is an explanatory diagram illustrating a storage example of the product DB 2103. The product DB 2103 is information indicating a display position of a product in a store for each product. Specifically, the product DB 2103 stores product information and product position information for each product in association with each other. In FIG. 7, the product DB 2103 stores, for example, information such as a product ID, a product name, and a price as product information for each product. In FIG. 7, the product DB 2103 stores, for each product, information of a shelf ID as the position information of the product in association with the information of the product.

The product ID is an identifier for uniquely identifying a product. The product ID is not particularly limited. The product ID may be a product code. The product code may be a product code of at least one of a Japanese Article Number (JAN) code, a European Article Number (EAN) code, or a Universal Product Code (UPC). Alternatively, the product ID may be a product name. The product name is a name of a product.

The shelf ID is an identifier for uniquely identifying a shelf. In the product DB 2103 of FIG. 7, the information of the shelf ID is used as position information in which products are displayed. The position information of the product is not limited to the information of the shelf ID. Information such as shelf tier numbers and aisle identifiers may be stored in the product DB 2103 as product position information. The price is the price of the product.

The product DB 2103 may not include a part of the illustrated contents. The product DB 2103 may include contents other than those illustrated. The product DB 2103 may store, for example, an attribute of a product. Examples of the attribute of the product include frozen, refrigerated, fresh, raw, size, and weight. For example, the size of the product is, for example, at least one of the length, width, and height of the product. For example, the weight of the product is the weight of the product alone.

A category of a product may be stored in the product DB 2103 as an attribute such as frozen, refrigerated, fresh, and raw. The categories of the products may be roughly classified. It may be sub-classified. For example, the category of the roughly classified products may be frozen, refrigerated, fresh, raw, normal temperature, or the like. The category of the roughly-classified product may be, for example, vegetables, meat, frozen, bread, dairy products, confectionery, daily necessities, and the like. Alternatively, the category of the sub-classified product may be milk, cheese, or the like. There may be a plurality of product categories. For example, there may be a roughly-classified category of dairy products and a sub-classified category of milk, such as dairy products and milk.

The product DB 2103 may further store information such as a best-before expiration, a product expiration date, and a manufacturer for each product.

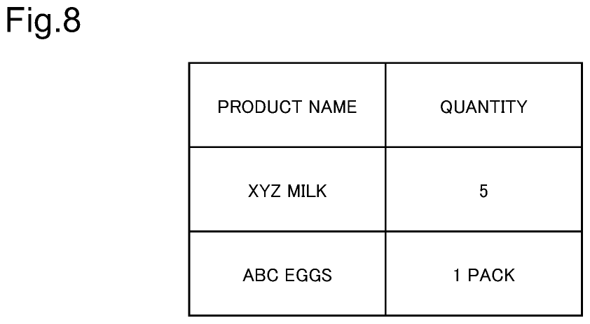

FIG. 8 is an explanatory diagram illustrating an example of a shopping list. The shopping list DB 2102 stores a shopping list for each customer. Specifically, the shopping list DB 2102 stores a shopping list for each customer ID. The shopping list stores information on a product that the customer wants to purchase. In FIG. 8, the shopping list stores, for example, information of a product name of a product desired to be purchased by the customer and a quantity of products desired to be purchased by the customer in association with each other. The product name is information that can identify a product. Although a product name is used for ease of description, a product ID or the like may be stored in the shopping list instead of the product name.

Although not illustrated, the shopping list is associated with, for example, information of a customer ID. Accordingly, the acquisition unit 212 to be described later can acquire the shopping list of the authenticated customer from the plurality of shopping lists included in the shopping list DB 2102 stored in the storage unit 216. In the second example embodiment, since the customer with customer ID A001 in FIG. 6 will be described as an example, the shopping list in FIG. 8 is a shopping list of the customer with customer ID A001 in FIG. 6.

The shopping list only needs to be able to identify the product by the customer, and information of a category obtained by subdividing each product may be stored instead of the information of the product name. For example, instead of a specific product name such as five XYZ milks and the purchase quantity, five milk or five liters may be simply stored in the shopping list.

<Creation of Shopping List>

First, creation of a shopping list will be described. The shopping list is created by a customer. The shopping list may be created by a terminal device of a customer or the like. The shopping list may be created using digital signage in a store.

First, for example, a case where a shopping list is created by a terminal device of a customer will be described. The type of the terminal device of a customer is not particularly limited as in a smartphone, a tablet-type device, and a personal computer (PC). For example, the customer may log in to the member system using the customer ID, the password, and the like by operating the terminal device of the customer. Then, the customer puts the product that the customer wants to purchase on the customer's shopping list by the member system.

Next, a case where the shopping list is created by the digital signage 20 installed in the store will be described. For example, the face feature amount acquisition unit 201 acquires the feature amount of the face of the customer. Specifically, the face feature amount acquisition unit 201 acquires the face feature amount from the customer's face image captured by an imaging device. The imaging device is, for example, a camera. The timing at which the face feature amount is acquired is not particularly limited. For example, when the customer stands at a position within a predetermined range where the face of the customer can be imaged by the imaging device of the digital signage 20, the face feature amount acquisition unit 201 may start to acquire the face feature amount. Alternatively, the display unit 202 may display a screen (not illustrated) having an authentication start button. When the start button is pressed, the face feature amount acquisition unit 201 may start acquiring the face feature amount.

Then, the face feature amount acquisition unit 201 transmits the acquired face feature amount to the identification unit 211 of the server 21. The identification unit 211 authenticates the face of the customer by matching the acquired face feature amount with the face feature amount registered in the customer DB 2101. Then, after the matching, the input receiving unit 205 receives, for example, designation of a product to be added to the shopping list by the customer via an input device. The input receiving unit 205 may further receive the planned purchase quantity of the product via the input device. The input device is not particularly limited. For example, the input receiving unit 205 may receive an input by voice via a microphone or the like. The input receiving unit 205 may receive an input by operating the screen via a touch panel display or the like. Then, the input receiving unit 205 transmits the received product information to the update unit 215 of the server 21. the update unit 215 adds the product information to the shopping list of the identified customer.

This is the end of the description of the creation of the shopping list. Next, an example of displaying a route will be described.

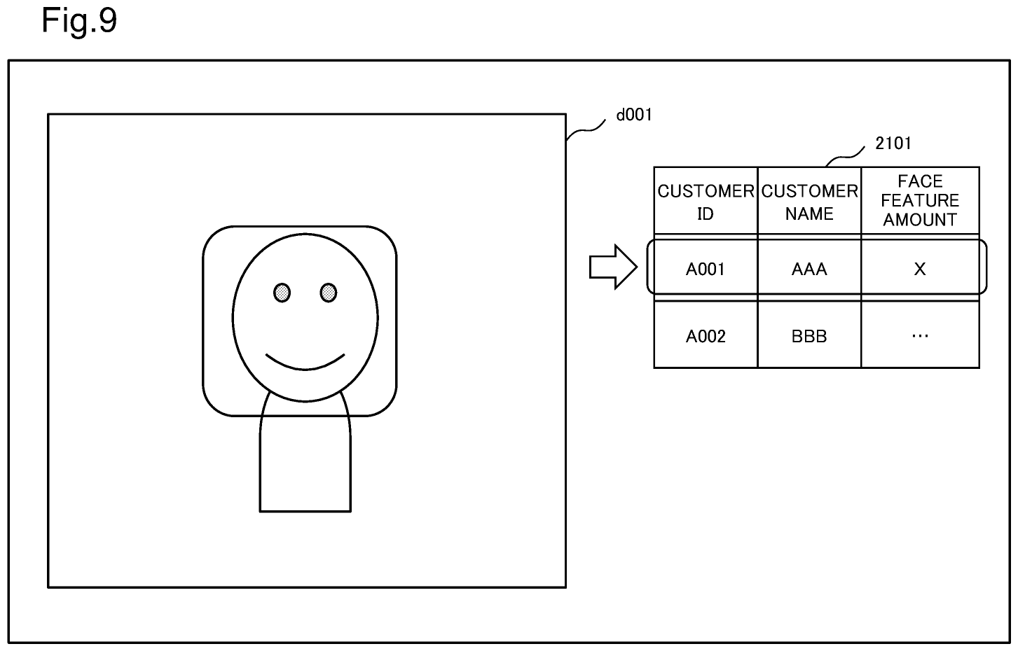

FIG. 9 is an explanatory diagram illustrating an authentication example based on the face feature amount. Similarly to the creation of the shopping list by the digital signage 20, the face feature amount acquisition unit 201 acquires the feature amount of the face of the customer. Specifically, in FIG. 9, the display unit 202 displays a screen d001 for capturing an image of the face of the customer by the imaging device. The face feature amount acquisition unit 201 acquires the face feature amount from the face image captured by the imaging device. The identification unit 211 authenticates the face of the customer by matching the acquired face feature amount with the face feature amount registered in the customer DB 2101.

Next, after the authentication, the acquisition unit 212 acquires the shopping list associated with the customer ID of the authenticated customer from shopping list DB 2102.

The generation unit 213 generates a route from the digital signage 20 to the product included in the shopping list based on the position of the product included in the shopping list and the position (position of the display device) of the digital signage 20 from which the face image has been acquired. Specifically, the generation unit 213 specifies the position of the product included in the shopping list from the product DB 2103. For example, since the digital signage 20 is fixedly arranged, the position of the digital signage 20 from which the face image is acquired can be specified in advance. Alternatively, the position of the digital signage 20 may be specified by positioning based on, for example, a beacon. Then, the generation unit 213 generates a route from the digital signage 20 to the product based on the position of the product, the position of the digital signage 20, and the map information of the store.

The display control unit 214 displays the generated route on the display unit 202. The display unit 202 displays the generated route. Specifically, for example, the display control unit 214 may send, to the display unit 202, display information in which a route is added onto an image indicating a map of the inside of the store. Then, the display unit 202 may display a map of the inside of the store including the route based on the display information. The voice output unit 203 may output a voice that guides the generated route using a speaker.

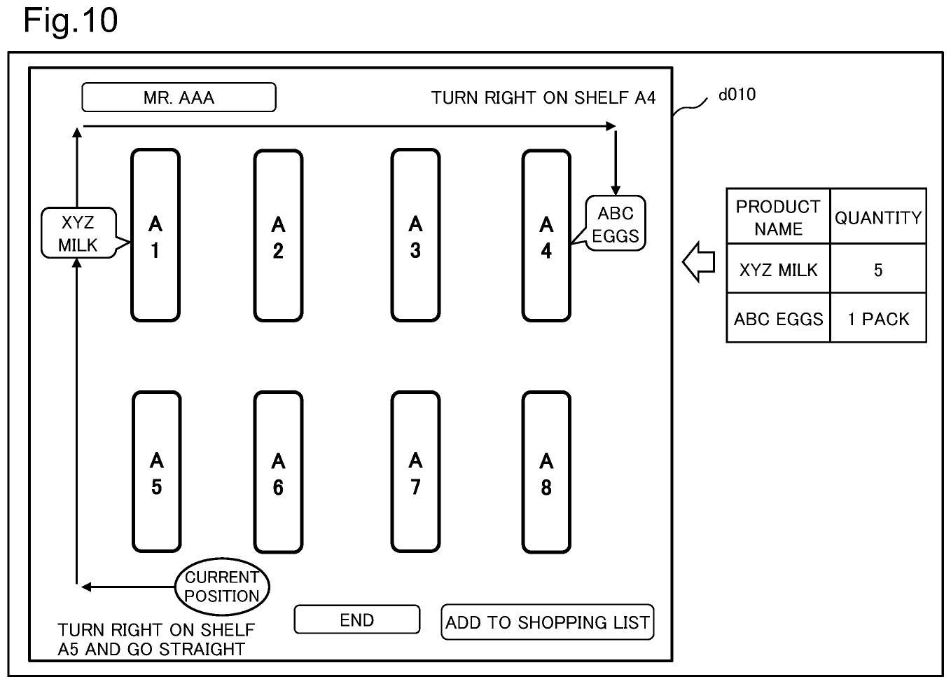

FIG. 10 is an explanatory diagram illustrating a display example of a route. The display unit 202 displays a screen d010. The screen d010 includes the current position and the position of the product via the route on the map of the store. On the screen d010, the current position is indicated at present. In FIG. 10, the current position is the position of the digital signage 20-1 where the face feature amount is acquired. The display unit 202 displays the screen d010 including a route from the digital signage 20-1 to XYZ milk and ABC eggs included in the shopping list. For example, on the screen d010, an arrow indicates a moving direction.

In FIG. 10, a balloon is used to represent the position of the product, but is not particularly limited. The position of the product may be displayed in stages. In FIG. 10, a balloon indicating the position of the shelf of the product is displayed on the map. Then, when this balloon is tapped, the display unit 202 may display a stage on which products are displayed on the shelf.

As illustrated in FIG. 10, the screen d010 is not limited to the route indicated by the arrow, and may include a route indicated by characters. On the screen d010, the route indicated by characters is, for example, “turn right on the shelf A5 and go straight”, “turn right on the shelf A4”, and the like. The voice output unit 203 may output the route by voice.

The screen d010 may include a button for adding a product to the shopping list, an end button, and the like. When the end button is tapped, the display unit 202 ends the display of the screen d010, for example. For example, when a button for adding a product to the shopping list is tapped, the product can be added. Additional examples of products will be described later.

The screen d010 may include information for identifying the customer. In FIG. 10, the screen d010 includes the name of the customer.

As illustrated in FIG. 10, the display unit 202 may display the screen d010 including a route through all the products included in the shopping list from the digital signage 20 for which the face authentication has been performed. The display unit 202 may be capable of enlarging a part of the screen d010.

A route generation method is not particularly limited. For example, the route may be generated in the order of various products. FIG. 10 illustrates a route through which milk and an egg pass in this order from the current position.

### Route Generation Example 1

For example, the generation unit 213 generates a route based on the order of the distance from the position of the digital signage 20 (display device) to the position of the product of the products included in the shopping list. Examples of the order of the distance include the order of the shorter distance and the order of the longer distance. For example, the generation unit 213 generates routes in ascending order of distance. As a result, the system 2 can pick up products desired to be purchased by the customer in order of proximity to the position where the customer is.

### Route Generation Example 2

The generation unit 213 generates a route based on the order of the information on the products in the shopping list. The order of the product information in the shopping list includes, for example, the order of addition to the shopping list. Specifically, for example, the generation unit 213 may generate a route in the order of addition to the shopping list. The customer is likely to add the information of the necessary product to the shopping list first. Therefore, the system 2 can first pick up the product required by the customer by generating the route based on the order of addition to the shopping list.

### Route Generation Example 3

The generation unit 213 generates a route based on the priority of the product in the list. The generation unit 213 may generate routes in descending order of priority. The priority may be given by the customer when the shopping list is created. After displaying the generated route, the priority may be newly designated by the customer. For example, after viewing the displayed route, the customer may designate a product to be picked up first as a product with high priority. Therefore, the digital signage 20 may include a reception unit (not illustrated). The reception unit (not illustrated) may receive selection of a product with high priority.

### Route Generation Example 4

The generation unit 213 generates the route based on the order according to the attribute of the products included in the shopping list. Examples of the attribute of the product include freezing, refrigeration, fresh, raw, size and weight of the product, and the like.

A case where a product corresponding to any of attributes such as freezing, refrigeration, fresh, and raw is included in the shopping list will be described as an example. The generation unit 213 generates a route through which a product corresponding to at least one of attributes such as frozen, refrigerated, fresh, and raw passes last or later. This can guide the customer to the store so that products such as frozen, refrigerated, fresh, and raw are picked up later. Therefore, the system 2 can suppress deterioration of these products.

Alternatively, for example, the generation unit 213 may generate a route based on the order of predetermined categories. The order of the predetermined categories may be a predetermined order. For example, the product DB 2103 may have product category information for each product. For example, the order may be determined in advance when it is desired to induce customers in the order of categories of vegetables and meat. A case where the order of vegetables, meat, and dairy products is determined in advance will be described. For example, in a case where tomato, carrot, chicken, and milk are included in the shopping list, the generation unit 213 generates, from the digital signage 20, a route through tomato and carrot and then through chicken and milk in this order. As a result, it is possible to guide the customer so that the convenience of the store is favorable. The system 2 can cause a customer to pick up a product so as not to oppose a flow of people.

The generation unit 213 may generate a route in order according to the size of the product. The size of the product is, for example, at least one of length, width, and height of the product. The size of the product may be the volume of the product. Specifically, the generation unit 213 generates a route through a product having a size equal to or larger than a predetermined size among the products included in the shopping list in the last or second half. The latter half may be designated, for example, at the end or any number from the beginning. The generation unit 213 generates a route through which a product larger than the other products included in the shopping list by a predetermined size or more passes at the end or the latter half. As a result, the system 2 can guide the store so that the product that is difficult to carry is picked up later.

The generation unit 213 may generate a route in order according to the weight of the product. The weight may be the weight of the product alone. The weight may be a product of a weight of the product alone and a planned purchase quantity. For example, the generation unit 213 may generate a route in which a product having a weight equal to or more than a predetermined weight among products included in the shopping list passes through at the end or the latter half. For example, the generation unit 213 may generate a route in which a product heavier than other products included in the shopping list by a predetermined weight or more passes through the end or the latter half. That is, the generation unit 213 generates a route such that an absolutely heavy product and a relatively heavy product are picked up later among the products included in the shopping list. As a result, it is possible to guide the store so that a product that is difficult to carry is picked up later. For example, the generation unit 213 may generate a route such that pickup of an absolutely light product and a relatively light product among the products included in the shopping list comes first. As a result, the system 2 can guide the store such that the product that is easy to carry is picked up first.

The above-described attributes may be a combination. The combination is not particularly limited. For example, a combination of a size and a weight may be used. When combined, there may be a priority in the attribute.

### Route Generation Example 5

The route may be generated based on the order according to the convenience of stores other than the category of the product. For example, the convenience of the store other than the category of the product includes a bargain product, a product with a small stock, a congestion status, and the like.

The generation unit 213 generates a route through which a predetermined product is preferentially passed among the products included in the shopping list. The predetermined product is, for example, a bargain product. Specifically, the generation unit 213 may generate a route through which bargain products are preferentially sold among the products included in the shopping list. For example, information indicating whether the product is a bargain product may be included in the product DB 2103. Prioritizing may be, for example, via first in the route or via the first half in the route, and is not particularly limited. The product prioritizing the transit in the route is not limited to a bargain product. The generation unit 213 may generate a route through which a product identified from a sales status in a store among products included in the shopping list is preferentially sold. As a result, the system 2 can suppress the customer from missing buying a product that is easy to sell, such as a bargain product.

The predetermined product may be, for example, a product with a small stock. Specifically, the generation unit 213 may generate a route through which a product with a small stock is preferentially passed among products included in the shopping list. When the inventory quantity is used, the product DB 2103 may have information of the inventory quantity for each product. Specifically, the generation unit 213 generates a route through which products whose inventory quantity is equal to or less than a predetermined quantity are preferentially routed among the products included in the shopping list. Alternatively, a DB for managing the stock for each product may be prepared. As a result, it is possible to suppress the customer from missing out on a product with a small stock.

The generation unit 213 may generate a route according to the congestion status. For example, the generation unit 213 may specify a congestion status from an image of the inside of the store captured by an imaging device attached in the store, and generate a route bypassing a crowded place. Alternatively, in a case where a product on the shopping list is in a crowded place, the generation unit 213 may generate a route such that the product in the crowded place comes later. As a result, the customer can shop while avoiding congestion.

### Route Generation Example 6

The generation unit 213 may generate a route based on purchase history information. For example, the storage unit 216 may store purchase history information for each customer. The purchase history information includes, for example, information of products purchased in the past for each customer. The generation unit 213 may specify a product that has been frequently purchased in the past from the purchase history information, and generate a route so as to pass near the product with a high purchase frequency. Alternatively, in a case where a product with a high purchase frequency is on the shopping list, the generation unit 213 may generate a route by giving priority to the product with a high purchase frequency. As a result, the product can be picked up by the route in consideration of the frequently bought product.

### Route Generation Example 7

For example, in a case where there is another product that can satisfy the discount condition by combination with the product included in the shopping list, the generation unit 213 generates a route from the digital signage 20 to the product and the other product. As a result, the system 2 can present a route including a product recommended to be purchased in combination with the product included in the shopping list.

For example, the storage unit 216 further stores a discount condition DB. The discount condition DB stores, for example, discount information in which a discount condition and a discount content are associated with each other. The discount condition indicated in the discount information is, for example, information, such as a product ID, that can uniquely identify a product that needs to be registered as a checkout target product for application of the discount. The discount content is, for example, any of a price, a discount amount, or a discount rate of a product after application of the discount, a price of a set of products, a discount amount for a set of products, or a discount rate.

The server 21 may include a specifying unit (not illustrated). The specifying unit (not illustrated) specifies another product that satisfies the discount condition when purchased in combination with a product included in the shopping list. Specifically, the generation unit 213 generates a route based on a position of a product included in the shopping list, a position of the digital signage 20, and a position of another product.

Here, a case where there is milk on the shopping list and the discount condition is simultaneous purchase of milk and bread will be described as an example. The generation unit 213 generates a route from the digital signage 20 to milk and bread based on the position of milk, the position of bread included in the shopping list, and the position of the digital signage 20. Which of milk and bread passes first may be determined by the generation unit 213 according to route generation examples 1 to 6 and the like.

The number of other products may be determined to be equal to or less than a predetermined number. The predetermined number may be determined in advance or may be specified by a customer. As a result, it is possible to suppress a large number of products not included in the shopping list from being included in the route.

### Route Generation Example 8

For example, the generation unit 213 may generate a route for finally going around a product close to the checkout device among the products included in the shopping list. As a result, it is possible to guide the customer to the store so that the customer can immediately go to the checkout device after picking up the product.

### Route Generation Example 9

For example, in a case where there are a plurality of floors of the store, the generation unit 213 generates a route for going around the products included in the shopping list by the same floor. As a result, it is possible to suppress generation of a route in which the customer goes back and forth between different floors.

This is the end of the description of each generation example of the route. The generation unit 213 may generate a route based on the transit order designated by the customer. Specifically, the digital signage 20 includes a transit-order designation receiving unit (not illustrated), and the transit-order designation receiving unit receives designation of the transit order. Then, the generation unit 213 may generate a route based on the received transit order.

<Display Example of Plurality of Routes>

The generation unit 213 may generate a plurality of routes. Then, the display unit 202 may display all of the plurality of generated routes. The display unit 202 may display one or a plurality of designated routes from the plurality of generated routes.

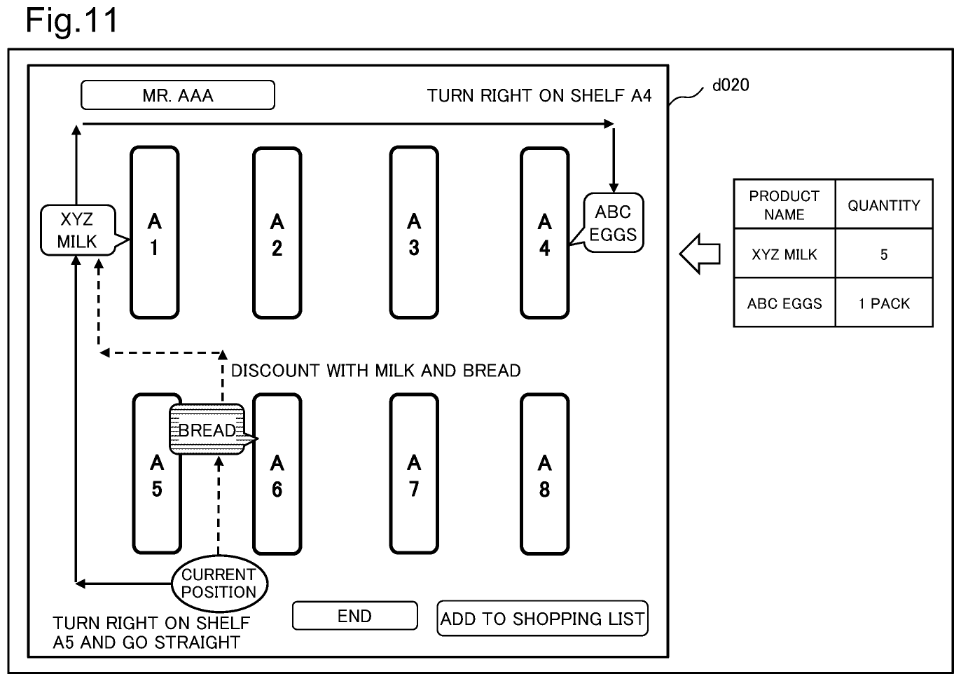

FIG. 11 is an explanatory diagram illustrating a display example of a plurality of routes. A screen d020 of FIG. 11 further includes a route according to route generation example 7 in the screen d020 illustrated in FIG. 10. In a case where the simultaneous purchase of milk and bread is the discount condition, since XYZ milk is on the shopping list, the display unit 202 displays the products included in the shopping list and the route via bread.

The display unit 202 may display the screen d020 such that a product (in FIG. 11, XYZ milk and ABC eggs are used) on the shopping list and a product (bread in FIG. 11) not on the shopping list can be distinguished from each other. For example, when a balloon of a product that is not in the shopping list is tapped, the display unit 202 may display a discount condition.

The display unit 202 may display a plurality of routes in different forms. The different form means that the shape of the display, the pattern of the display, the color of the display, the size of the display, and the like are different. In FIG. 11, a route passing through bread is indicated by a broken line, and a route not passing through bread is indicated by a solid line.

In a case where a part of the plurality of routes overlaps, the display unit 202 may display one route in the overlapped portion. In FIG. 11, since XYZ milk to ABC egg are the same in two routes, the display unit 202 does not display wavy lines of overlapping portions.

When a plurality of routes are generated, the display unit 202 may display a more recommended route among the plurality of routes in an identifiable manner. A route recommended more than other routes is referred to as a most recommended route. For example, the display unit 202 displays the recommended route again and other routes in different forms. The different form means that the color, the thickness of the arrow indicating the route, the type of the line of the arrow, and the like are different. For example, the display unit 202 may add a word indicating the most recommended route to the most recommended route. For example, when a product included in the shopping list is extremely heavy, the display unit 202 may set a route in which the product is the last as the most recommended route. Whether the product is extremely heavy may be determined by comparison with a predetermined weight, or may be determined by comparison with the weight of another product included in the shopping list.

For example, a case where 25 Kg of rice and 1 Kg of frozen food are included in the shopping list will be described as an example. In the order according to the attributes of the products, the generation unit 213 generates a route to reach the frozen food via rice from the digital signage 20. In the order according to the weight of the product, the generation unit 213 generates, from the digital signage 20, a route to reach the rice via the frozen food. In this manner, the route varies depending on the transit order. Since 25 Kg of rice is extremely heavy, the display unit 202 displays a route to reach the rice via the frozen food as the most recommended route. When there is an extremely heavy product, a route that goes around the heavy product last can be more recommended. In this manner, a more recommended route can be presented depending on the products included in the shopping list.

For example, when 2 Kg of rice and 1 Kg of frozen food are included in the shopping list, the generation unit 213 can generate a plurality of routes according to the transit order. However, if 2 Kg of rice is not extremely heavy, the display unit 202 may not present the most recommended route.

In a case where a large number of products are included in the shopping list, it is predicted that it takes time to pick up the products. In a case where there is one refrigerated or frozen product among a large number of products, the display unit 202 may display a last route to reach a refrigerated or frozen food as the most recommended route among a plurality of routes.

When a plurality of routes are generated, the display unit 202 may not display routes other than the most recommended route among the plurality of routes.

When a plurality of routes are displayed, the display unit 202 may not display the route designated by the customer. Specifically, the digital signage 20 may include a route non-display receiving unit (not illustrated). Then, the route non-display receiving unit may receive designation of a route not to be displayed by the customer. Then, the display unit 202 does not display the designated route from the plurality of displayed routes. As a result, it is possible for the customer to exclude routes that are not used from the plurality of displayed routes and display the routes.

The display control unit 214 may control the display unit 202 not to display routes other than the route designated by the customer. Specifically, the digital signage 20 may include a route display reception unit (not illustrated). Then, the route display reception unit (not illustrated) may receive designation of a route to be displayed by the customer. Then, the display control unit 214 does not cause the display unit 202 to display routes other than the designated route from the plurality of displayed routes. As a result, the display unit 202 displays the designated route and does not display routes other than the designated route. Therefore, the customer can select a route to be used from the plurality of displayed routes and display the selected route.

<Deletion of Product from Shopping List by Digital Signage 20>

Next, an example of deleting a product from a shopping list using the digital signage 20 will be described. It is assumed that the customer deletes a product from the shopping list, for example, when the customer picks up the product or a product similar to the product.

The selection receiving unit 204 receives the selection of the information on the products included in the shopping list by the operation of the customer. A reception method by the selection receiving unit 204 is not particularly limited. Specifically, the selection receiving unit 204 receives the selection of product information for the input device. More specifically, the selection receiving unit 204 may receive the selection of the product information by an input on a screen displayed by the digital signage 20. Alternatively, the selection receiving unit 204 may receive the selection of the product information by voice. The selection receiving unit 204 sends the information on the product received as a deletion target to the update unit 215 of the server 21.

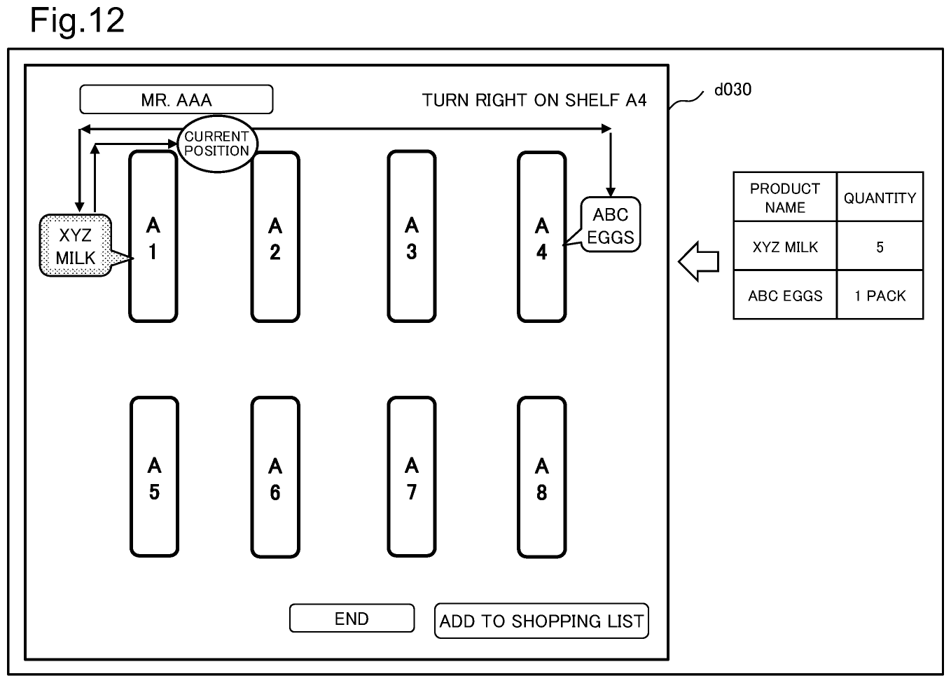

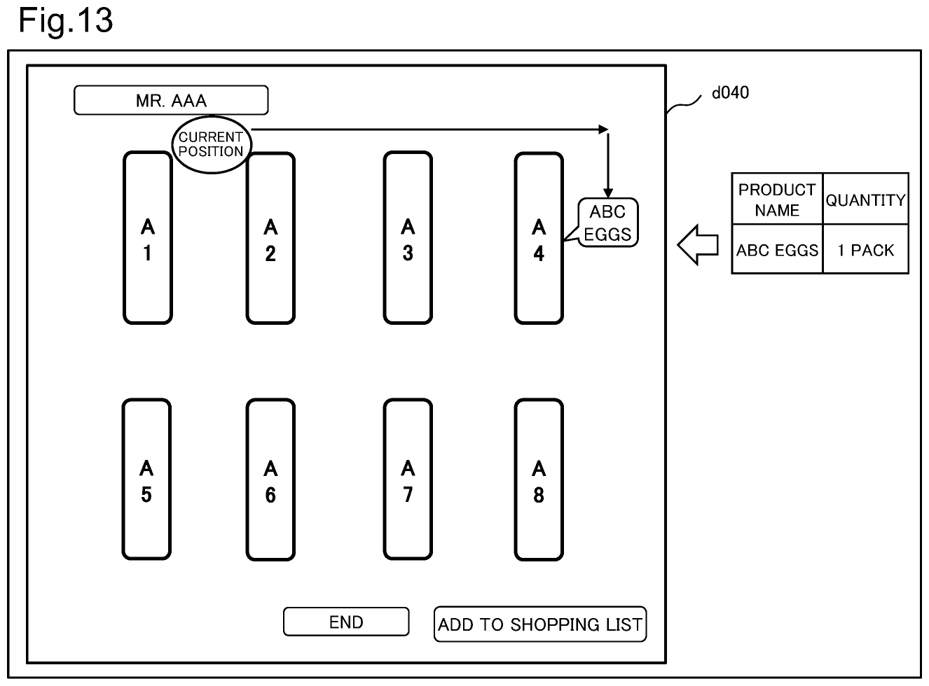

The update unit 215 deletes information on the selected product from the shopping list. The generation unit 213 generates the route based on the updated shopping list. A specific example will be described with reference to FIGS. 12 and 13.

FIG. 12 is an explanatory diagram illustrating an example of selecting a picked-up product. In FIG. 12, the customer performs face authentication using the digital signage 20-2. Therefore, the current position is the position of the digital signage 20-2. The shopping list illustrated in FIG. 12 is before the update. The display unit 202 displays a screen d030 including a route from the digital signage 20-2 to each product included in the shopping list. Since the buttons, the display, and the like included in the screen d030 are as described above, the details thereof will be omitted.

When the product name displayed on the screen d030 is tapped, the selection receiving unit 204 receives, for example, the selection of a product having the tapped product name. In FIG. 12, XYZ milk is selected. The update unit 215 deletes the information of the XYZ milk from the shopping list.

FIG. 13 is an explanatory diagram illustrating a display example of a route after a product selected from a shopping list is deleted. In FIG. 13, the shopping list does not include information on XYZ milk. Then, the generation unit 213 generates a route from the digital signage 20-2 to the product (ABC egg) included in the shopping list from which the XYZ milk has been deleted. The display unit 202 displays a screen d040 including the generated route. The screen d040 displays the generated route on the map of the store, for example.

As described above, since the digital signage 20 includes the input device such as the touch panel display, the customer can easily delete the already picked-up product or the like from the shopping list by operating the input device.

<Adding Product to Shopping List with Digital Signage 20>

Next, an example of adding a new product to the shopping list using the digital signage 20 will be described.

The input receiving unit 205 receives an input of new product information. A reception method by the input receiving unit 205 is not particularly limited. Specifically, the input receiving unit 205 receives an input of product information by the input device. More specifically, for example, the input receiving unit 205 receives voice input of product information with a microphone. Alternatively, for example, the input receiving unit 205 may receive the input of the product information by searching the product information or the like. The input receiving unit 205 may receive information of a quantity together with information of a product. The input receiving unit 205 sends the received product information and quantity information to the update unit 215 of the server 21.

The update unit 215 adds information of the received product to the shopping list. In a case where the information of the quantity is received, the update unit 215 adds the information of the product and the information of the quantity to the shopping list in association with each other.

An example in which a cookie is added to the shopping list illustrated in FIG. 13 will be described. For example, when an additional button is tapped on the shopping list included in the screen illustrated in FIG. 13, the display unit 202 may display a screen (not illustrated) for receiving an input of information of a new product. Then, the input receiving unit 205 receives an input of information of a new product using a screen (not illustrated). For example, it is assumed that the input receiving unit 205 receives a ZOO cookie as a product and two boxes as a quantity. The update unit 215 adds the received product and quantity to the shopping list.

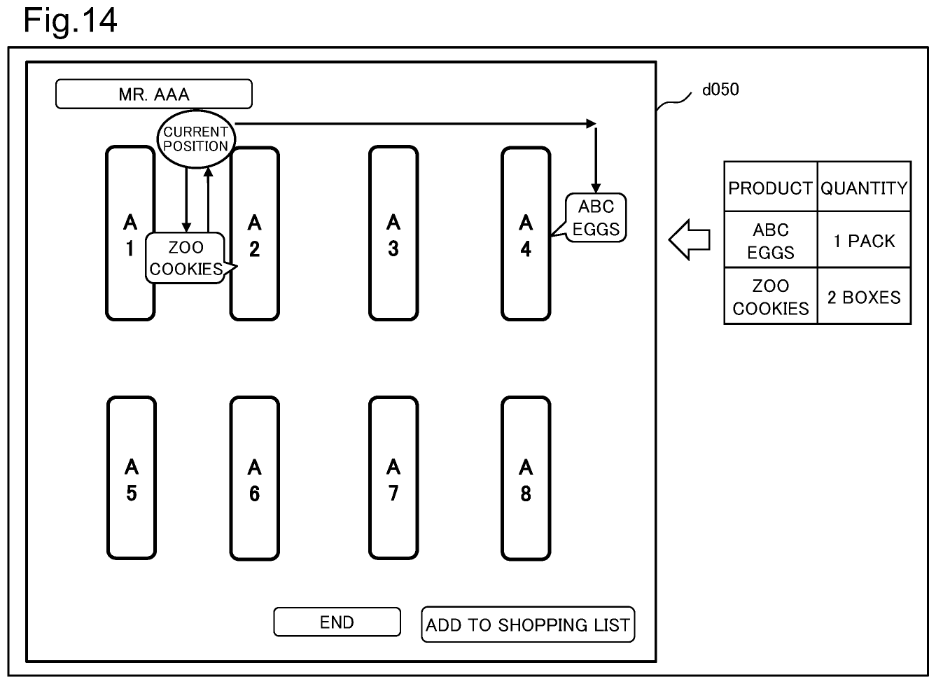

FIG. 14 is an explanatory diagram illustrating an addition example of a new product. In FIG. 14, two boxes of ZOO cookies are added to the shopping list. The generation unit 213 generates the route based on the position of the product included in the updated shopping list. The display unit 202 displays a screen d050 including the generated new route.

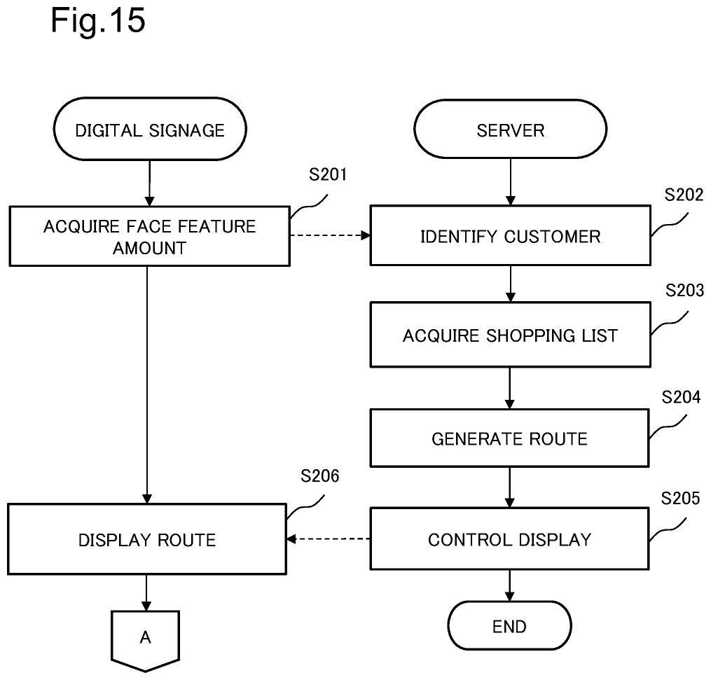

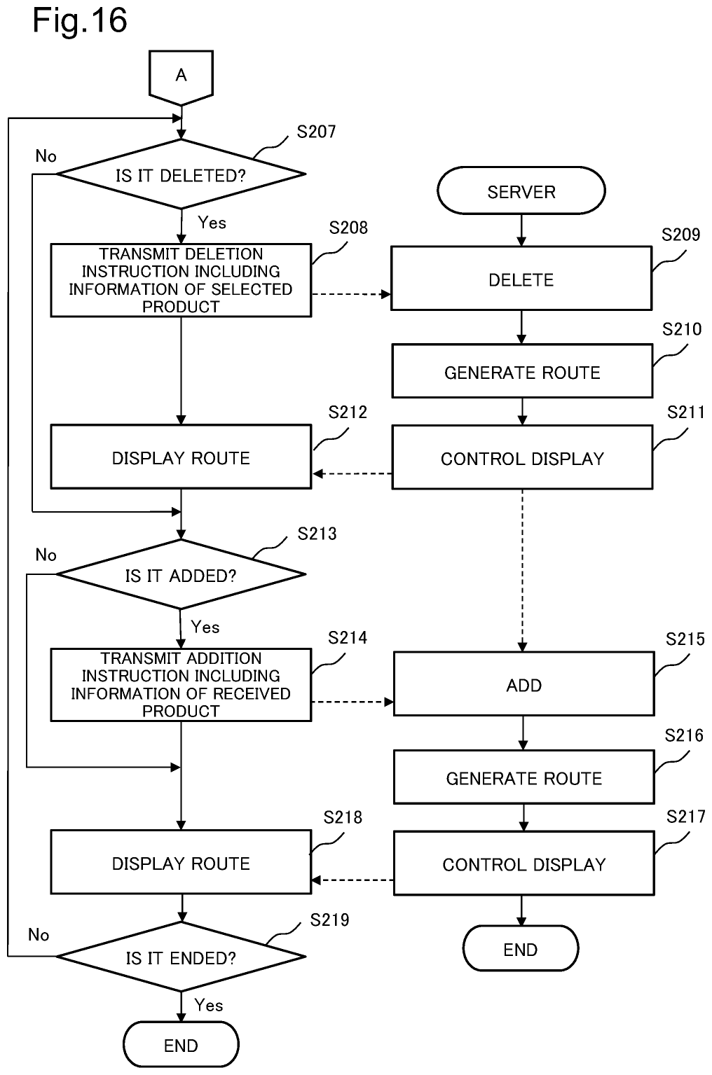

FIG. 15 and FIG. 16 are flowcharts illustrating an operation example of the system 2 according to the second example embodiment. First, the digital signage 20 acquires a face feature amount (step S201). In step S201, the digital signage 20 acquires the face feature amount from the image of the face of the customer captured by the imaging device. Then, the digital signage 20 transmits the face feature amount to the server 21. The digital signage 20 may transmit the face feature amount in association with the identification information of the digital signage 20. As a result, the server 21 can determine from which digital signage 20 the route should be generated.

Next, the identification unit 211 identifies the customer based on the face feature amount (step S202). Specifically, in step S202, the identification unit 211 identifies the customer by matching the acquired face feature amount with each face feature amount stored in the customer DB 2101.

Next, the acquisition unit 212 acquires a shopping list of the identified customer (step S203). The generation unit 213 generates a route (step S204). In step S204, the server 21 generates a route from the digital signage 20 to the product included in the shopping list based on the position of the product included in the shopping list and the position of the digital signage 20 that has acquired the face feature amount. The server 21 can specify the position of the product included in the shopping list from the product DB 2103. It is assumed that the information of the position of the digital signage 20 is stored in the storage unit 216 or the like in advance as described above.

The display control unit 214 displays the generated route on the digital signage 20 (step S205). Then, the display unit 202 displays the route (step S206).

The selection receiving unit 204 determines whether selection of a product has been received as a deletion target from products included in the shopping list (step S207). When the selection of the product has not been received (step S207: No), the digital signage 20 proceeds to step S213. When receiving the selection of a product as a deletion target (step S207: Yes), the selection receiving unit 204 transmits a deletion instruction including information of the selected product to the server 21 (step S208).

The update unit 215 deletes the information on the selected product from the shopping list (step S209). The generation unit 213 generates a route from the digital signage 20 to the product included in the updated shopping list (step S210). The display control unit 214 controls the display of the generated route (step S211).

The display unit 202 displays the route (step S212). Next, the input receiving unit 205 determines whether an input of product information has been newly received (step S213). When it is determined that the input of the product information has not been newly received (step S213: No), the digital signage 20 proceeds to step S218. When it is determined that the input of the information of the product is newly received (step S213: Yes), the input receiving unit 205 transmits an addition instruction including the received information of the product to the server 21 (step S214).

The update unit 215 adds information of the received product to the shopping list (step S215). The generation unit 213 generates a route from the digital signage 20 to the product included in the updated shopping list (step S216). The display control unit 214 controls the display of the generated route (step S217).

The display unit 202 displays the route (step S218). Next, the reception unit (not illustrated) determines whether the end button has been tapped (step S219). When the end button has not been tapped (step S219: No), the digital signage 20 returns to step S207. When the end button has been tapped (step S219: Yes), the digital signage 20 ends the operation of the flow.

Next, effects of the second example embodiment will be described. The server 21 generates a route in the store based on the position of the product included in the identified customer's shopping list and the position of the digital signage 20 from which the face feature amount has been acquired, and displays the route. Thus, the system 2 can reducing the cost of guiding a customer to a product on a shopping list. Even if the customer does not have a terminal device or a paper map of a store, the customer can easily find a product to be purchased.

Since the route is displayed on a relatively large screen by using the digital signage 20 as the display device, the customer can easily confirm the route.

The digital signage 20 receives selection of information of a product included in the shopping list according to the operation of the customer. Then, the server 21 deletes the information of the selected product from the shopping list. As a result, the customer can easily delete a picked-up product or the like from the shopping list using a device such as the digital signage 20 including the display device and the input device.

The digital signage 20 newly receives an input of product information. Then, the server 21 adds information of the received product to the shopping list. As a result, the customer can easily add a product to the shopping list using a device such as the digital signage 20 including the display device and the input device.

The server 21 generates a route based on the order of the distance from the position of the display device to the position of the product included in the shopping list. As a result, the product desired to be purchased by the customer can be picked up in the order of proximity to the position where the customer is.

The server 21 generates a route based on the order of the product information in the shopping list. The customer is likely to add the information of the necessary product to the shopping list first. Therefore, by generating the route based on the order of addition to the shopping list, the customer can pick up a more necessary product first.

The server 21 generates a route based on the order according to the attribute of the products included in the shopping list. The attribute of the product is, for example, at least one of frozen, refrigerated, raw, fresh food, the size of the product, and the weight of the product. Specifically, the server 21 can guide the route so that products such as frozen products, refrigerated products, raw products, and fresh food are picked up later. Therefore, deterioration of these products can be suppressed. The server 21 generates a route through which a product whose size is larger than a predetermined size passes last or in the latter half. The size of the product is, for example, at least one of length, width, and height of the product. The server 21 may generate, for example, a route in which a product having a weight equal to or more than a predetermined weight passes through the end or the latter half. As a result, it is possible to guide the route such that pickup of a product that is difficult to carry such as a heavy product or a large product is performed later.

The server 21 generates a route based on the order according to the congestion status in the store. The server 21 may specify a congestion status from an image of the inside of the store captured by an imaging device or the like attached to the inside of the store, and generate a route bypassing a crowded area. A method for specifying the congestion status is not particularly limited. For example, an area having a predetermined number or more of people may be considered to be crowded. The device that specifies the congestion status may not be the server 21, and the server 21 may acquire information regarding the congestion status from another device. As a result, the system 2 can suppress the customer from missing buying a product that is easy to sell, such as a bargain product.

In a case where there is another product that can satisfy the discount condition by combination with the product included in the shopping list, the server 21 generates a route from the digital signage 20 to the product and the other product. For example, if the discount condition is simultaneous purchase of milk and bread and there is milk on the shopping list, the server 21 generates a route from the digital signage 20 to the milk and bread based on the position of the milk, the position of the bread, and the position of the digital signage 20. As a result, the store side can present a route through which other products desired to be recommended to be purchased in combination can also pass. Therefore, the server 21 can further support the purchase of the product.

The digital signage 20 displays the entire route through all the products included in the shopping list. As a result, the customer can confirm the entire route from the digital signage 20 to the product included in the shopping list at a glance.

The digital signage 20 outputs a voice that guides the generated route. As a result, the customer can more easily find a desired product in the store only by listening to the guide.

The second example embodiment is not limited to the example described above, and various modifications can be made. A modification of the second example embodiment will be described below.

### First Modification of Second Example Embodiment

In the second example embodiment, when the end button is tapped, the display of the route for the authenticated customer is ended, but the present invention is not limited thereto. For example, if the digital signage 20 has a motion sensor, a detection unit (not shown) may detect by the motion sensor that an authorized customer has moved away from the digital signage 20. The display unit 202 may terminate the display of various screens when the detection unit detects that the customer has moved away from the digital signage 20.

### Second Modification of Second Example Embodiment

In the second example embodiment, an example has been described in which a route from the digital signage 20 to a product included in the shopping list is displayed on the digital signage 20. For example, in the second example embodiment, a route through other products other than the products included in the shopping list may be displayed on the digital signage 20. For example, other products include a bargain product, a product specified from a purchase history, and the like in addition to those described in the route generation example 7. The product specified from the purchase history is, for example, a product specified as frequently purchased from the purchase history. The number of other products may be determined to be equal to or less than a predetermined number. As a result, it is possible to suppress a large amount of products not included in the shopping list from being included in the route.

For example, the generation unit 213 generates a route from the digital signage 20 to the product included in the shopping list and the other product based on the position of the product included in the shopping list, the position of the other product, and the position of the digital signage 20. Further, if there is another product within the predetermined range from the product included in the shopping list, the generation unit 213 may generate a route from the digital signage 20 to the product included in the shopping list and the other product.

In a case where the other product is a bargain product, the display unit 202 may display such that it can be identified as a bargain product. In a case where another product is a product that is frequently purchased, the display unit 202 may display the product so that it can be identified that the product is a product that is frequently purchased.

Although not included in the route, the display unit 202 may display the generated route together with the positions of other products. The number of other products may be determined to be equal to or less than a predetermined number. As a result, it is possible to suppress a large number of products not included in the shopping list from being displayed.

### Third Modification of Second Example Embodiment

In the second example embodiment, a supermarket is taken as an example, and a food is taken as an example of a product, and the attribute and the category of the product are described. However, the contents of the attribute and the category may be variously changed according to the store and the product.

For example, in the case of a drug store, the attribute is the size of the product, the weight of the product, and the like. The attribute may be a product or the like that needs to be sold by a clerk having a predetermined qualification. For example, in a case where a product that needs to be sold by a clerk having a predetermined qualification is on the shopping list, the generation unit 213 may generate a route according to the check-in schedule of the clerk. The category may be a rough category such as medicine, daily necessities, food, and the like. For example, a predetermined category order such as a category order of medicine and food may be defined.

For example, in the case of the home center, the attribute is the size of the product, the weight of the product, and the like. The attribute may be a product or the like requiring customer service by a store clerk. For example, in a case where a product requiring customer service by a store clerk is on the shopping list, the generation unit 213 may generate a route from the digital signage 20 to each product included in the shopping list so that the product is the last. The category may be roughly classified into, for example, gardening supplies, pet supplies, supplies related to home equipment, and the like. For example, a predetermined category order such as a category order of pet supplies and gardening supplies may be determined.

The description of the modification is ended. In the second example embodiment, the server 21 includes the identification unit 211, the generation unit 213, the update unit 215, and the display control unit 214, but is not limited thereto. For example, the digital signage 20 may include the identification unit 211, the generation unit 213, the update unit 215, and the display control unit 214. The customer DB 2101, the shopping list, and the product DB 2103 may be stored in a storage device or the like different from the server 21. As described above, which device (information processing apparatus) has each functional unit and information is not particularly limited.

The digital signage 20 of the second example embodiment is an example of a display device, and another display device in a store may be used.

All the functional units illustrated in FIG. 5 may not be included. For example, the voice output unit 203 may not be provided. In a case where product information is not added to the shopping list, the input receiving unit 205 may not be included.

### Third Example Embodiment

Hereinafter, a third example embodiment will be described in detail with reference to the drawings. A third example embodiment describes an example in which, in self-scan shopping by a terminal device, a product registered as a product is deleted from a shopping list, and a route is generated based on the shopping list after the deletion. The third example embodiment will be described using a digital signage as a display device. In the third example embodiment, face authentication is described as an example of a method for identifying a customer. Hereinafter, description of contents overlapping with the above description will be omitted to the extent that the description of the third example embodiment is not unclear. In the third example embodiment, as in the second example embodiment, a supermarket is taken as an example of a store, and food is taken as an example of a product, but the store and the product are not particularly limited.

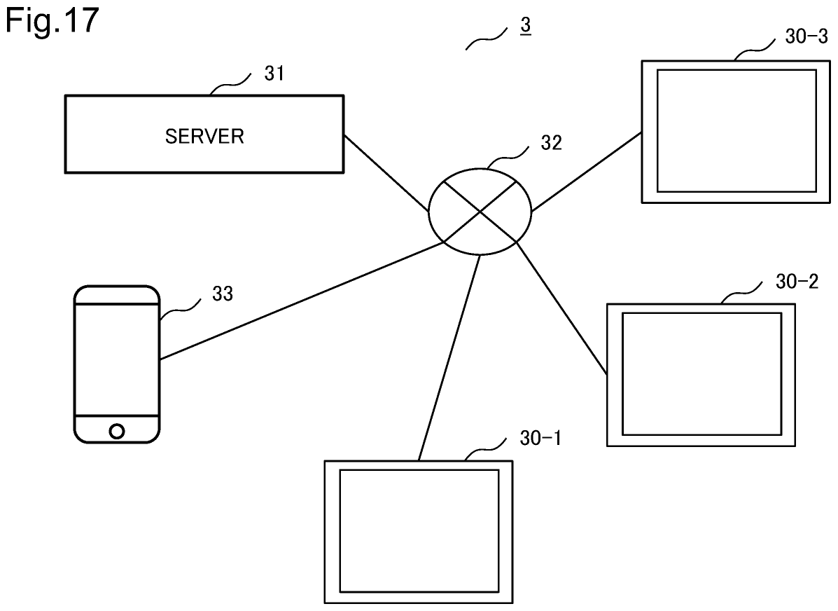

FIG. 17 is an explanatory diagram illustrating an example of a system according to the third example embodiment. A system 3 includes a server 31, a plurality of digital signages 30-1 to 30-3, and a terminal device 33. The server 31, the digital signages 30-1 to 30-3, and the terminal device 33 are connected via a communication network 32. In the example of FIG. 17, the number of digital signages 30 is 3, but is not particularly limited.

As in the second example embodiment, the server 31 is a device that generates a route to a product on a shopping list. Similarly to the plurality of digital signages 20-1 to 20-3 of the second example embodiment, each of the plurality of digital signages 30-1 to 30-3 include a display device such as a touch panel display. Then, as in the second example embodiment, each of the digital signages 30-1 to 30-3 displays a route from its own device to a product on a shopping list to guide the customer to the route. The digital signages 30-1 to 30-3 are installed in a store as in the second example embodiment. Here, it is assumed that the installation positions of the digital signages 30-1 to 30-3 are the same as the installation positions of the digital signages 20-1 to 20-3 of the second example embodiment illustrated in FIG. 4. The terminal device 33 can be operated by a customer, and is used to register a product purchased by the customer as a checkout target product. The terminal device 33 is a portable terminal. The terminal device 33 is not particularly limited as in a smartphone, a tablet-type device, a PC, or the like. In the terminal device 33, for example, an application program capable of registering the product information is installed. The terminal device 33 may be a terminal device of a customer. Alternatively, the terminal device 33 may be a terminal device of a store lent from the store to the customer.

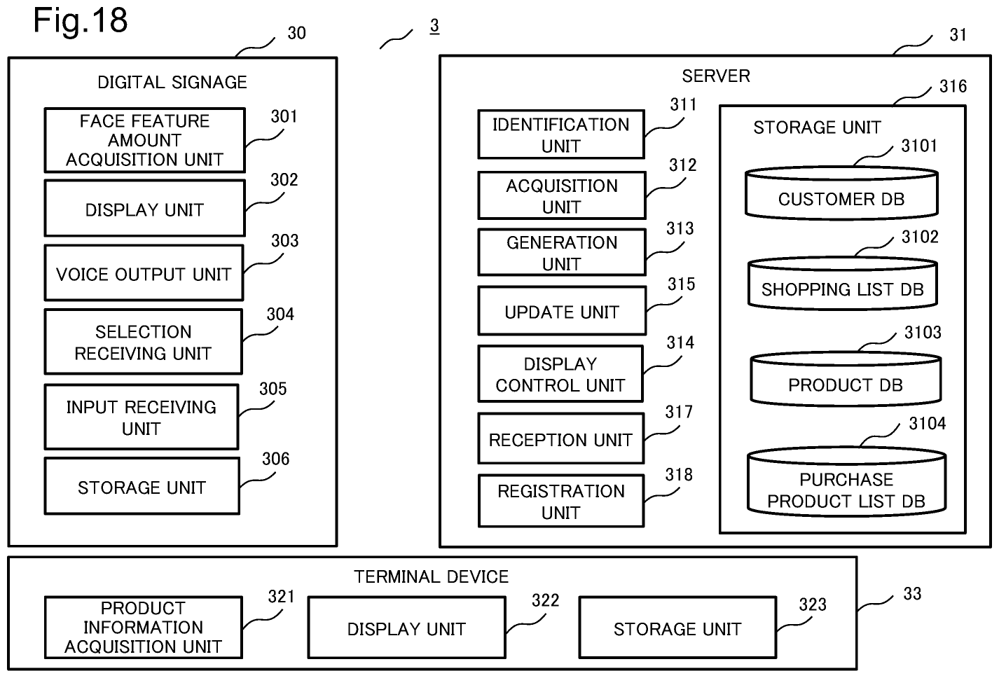

FIG. 18 is a block diagram illustrating a configuration example of the system 3 according to the third example embodiment. As described with reference to FIG. 17, the system 3 includes the digital signage 30, the server 31, and the terminal device 33.

The digital signage 30 includes a face feature amount acquisition unit 301, a display unit 302, a voice output unit 303, a selection receiving unit 304, an input receiving unit 305, and a storage unit 306. The digital signage 30 has no functional unit newly added from the second example embodiment. Each functional unit of the digital signage 30 may be similar to each functional unit described in the second example embodiment, and a detailed description thereof will be omitted.

The server 31 includes an identification unit 311, an acquisition unit 312, a generation unit 313, an update unit 315, a display control unit 314, a reception unit 317, a registration unit 318, and a storage unit 316. In the server 31, the reception unit 317 and the registration unit 318 are newly added from the second example embodiment. The identification unit 311, the acquisition unit 312, the generation unit 313, the update unit 315, and the display control unit 314 may be similar to the identification unit 211, the acquisition unit 212, the generation unit 213, the update unit 215, and the display control unit 214 described in the second example embodiment, respectively, and a detailed description thereof will be omitted. The storage unit 316 may be similar to the storage unit 216 described in the second example embodiment. However, in addition to customer DB 3101, shopping list DB 3102, and product DB 3103, purchase product list DB 3104 is newly stored in storage unit 316 from the second example embodiment. The customer DB 3101, the shopping list DB 3102, and the product DB 3103 may be similar to the customer DB 2101, the shopping list DB 2102, and the product DB 2103 described in the second example embodiment.

The purchase product list DB 3104 stores, for each customer, the latest purchase product list for which checkout has not been completed. The purchase product list stores, for example, information for identifying a customer, information on a product to be purchased by the customer, and information on a purchase quantity in association with each other for each customer. The information for identifying the customer is not particularly limited as long as the information can uniquely identify the customer, for example. Here, the information for identifying the customer will be described using information of a customer ID registered in the customer DB 3101 as an example. The purchase product list can be uniquely identified by the customer ID. As described above, the customer ID is associated with the shopping list of each customer. Therefore, the server 31 can associate the purchase product list with the shopping list for each customer.

The product information here may be any information that can uniquely identify a product. Examples of the product information include product ID information. As a result, the purchased product list is associated with the product DB 3103 by the information of the product ID. Therefore, by referring to the purchase product list, the server 31 can obtain the information of the price of the product, the name of the product, and the like from the product DB 3103 by the information of the product ID registered in the purchase product list. The purchase product list may store information on the price of a tax-included product as the product information based on the information on the price of the product. The purchase product list may further include, for each customer, total purchase price information and total purchase quantity information.

The purchase product list DB 3104 may not include a part of the above-described information regarding the purchase product list. The purchase product list DB 3104 may include information other than the above-described information regarding the purchase product list.

The terminal device 33 includes a product information acquisition unit 321, a display unit 322, and a storage unit 323. The storage unit 323 stores, for example, a processing result of each functional unit of the terminal device 33. Examples of the storage unit include a ROM, a RAM, a semiconductor memory, an HDD, and an SSD. The storage unit 323 may be a combination thereof.

The product information acquisition unit 321 acquires information on a product to be checked out by the operation of the customer. A method of acquiring the product information by the product information acquisition unit 321 is not particularly limited. The product information acquisition unit 321 may read the product code attached to the product via the imaging device. The product information acquisition unit 321 transmits the acquired product information to the server 31.

The reception unit 317 receives, from the terminal device 33, information on the product to be checked out, which is acquired by the operation of the customer in the terminal device 33. The registration unit 318 registers the received product information with respect to the purchase product list of the customer. A detailed description of a display example of the purchase product list after registration of the product information by the terminal device 33 is omitted in order to facilitate the description.

The update unit 315 deletes the received information on the product to be checked out from the shopping list. The generation unit 313 generates a route based on the updated list.

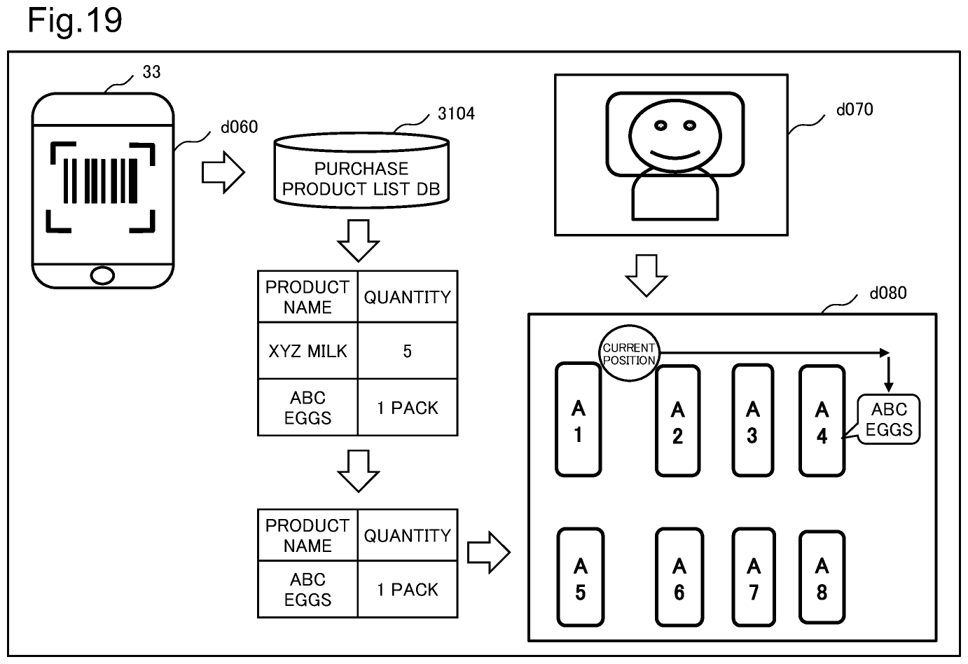

Next, an example in which information on a product registered as a checkout target in self-scan shopping is deleted from a shopping list will be described with reference to FIG. 19.

FIG. 19 is an explanatory diagram illustrating an example in which information on products to be checked out is deleted from a shopping list. In FIG. 19, the display unit 322 of the terminal device 33 displays a screen d060 on which a barcode obtained by one-dimensionally encoding a product code can be read. Then, the product information acquisition unit 321 acquires the product code by reading the barcode using the imaging device. The product information acquisition unit 321 obtains a product code by decoding the read barcode. The product information acquisition unit 321 may acquire the purchase quantity. For example, the product information acquisition unit 321 sends the acquired product code to the registration unit 318 and the update unit 315.

Then, the registration unit 318 registers the acquired product code in the purchase product list of the customer. The update unit 315 deletes the information on the product relevant to the product code from the shopping list. The information of the product relevant to the product code can be specified by the product DB 3103. In FIG. 19, a product name of XYZ milk and a quantity of five records associated with XYZ milk are deleted from the shopping list.

The display unit 302 displays a face authentication screen d070. Then, the customer performs face authentication with the digital signage 30. The face feature amount acquisition unit 301 acquires the face feature amount from the face image of the customer. The face feature amount acquisition unit 301 sends the acquired face feature amount to the server. The identification unit 311 authenticates the customer based on the face feature amount. Then, the generation unit 313 generates a route from the digital signage 30 to the product based on the position of the product (ABC egg) included in the authenticated customer's shopping list and the position of the digital signage 30. Then, the display unit 302 displays a screen d080 including the route. Here, the shopping list used for generating the route is an updated shopping list in which XYZ milk has already been deleted.

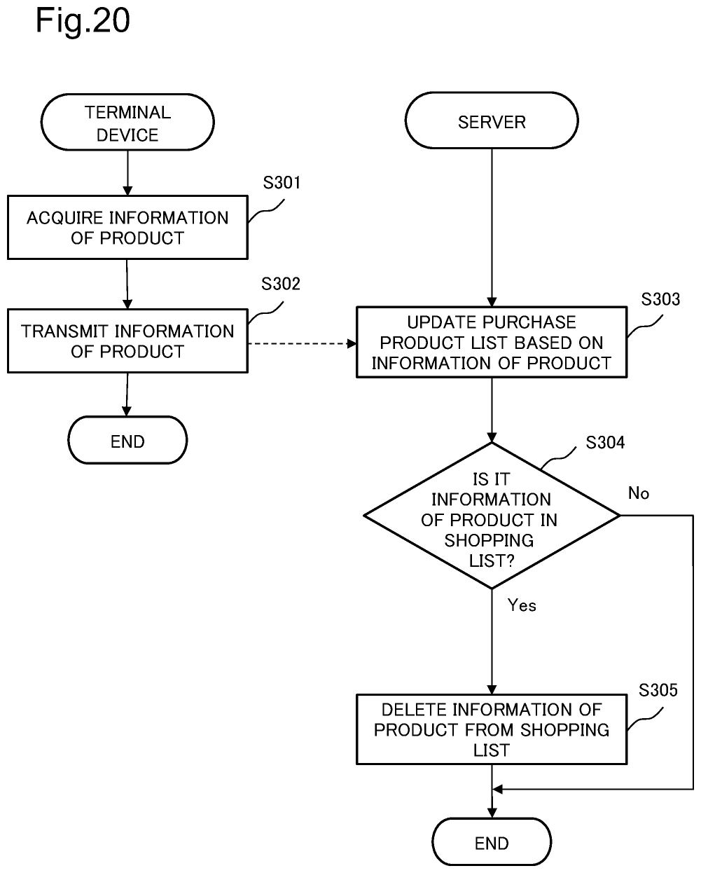

FIG. 20 is a flowchart illustrating an operation example of the system 3 according to the third example embodiment. The product information acquisition unit 321 acquires product information such as a product code (step S301). In step S301, the product information acquisition unit 321 may acquire the information on the purchase quantity together with the information on the product. The product information acquisition unit 321 transmits product information to the server 31 via a communication interface or the like (step S302). The registration unit 318 updates the purchase product list based on the product information (step S303). The update unit 315 determines whether the received information on the product is information on a product in the shopping list (step S304).

In a case where the information is the information of the product in the shopping list (step S304: Yes), the update unit 315 deletes the information of the product from the shopping list (step S305). After step S305, the system 3 ends the operation of the flow. On the other hand, when the information is not the information of the product in the shopping list (step S304: No), the system 3 ends the operation of the flow.

When the customer performs the face authentication using the digital signage 30, the generation unit 313 generates a route based on the shopping list after the information of the product registered as a checkout target is deleted. Then, the digital signage 30 can display a route based on the shopping list from which the information on the product registered as a checkout target has been deleted.

The flowchart from the face authentication to the display of the route may be similar to that of the second example embodiment, and thus a detailed description thereof will be omitted.

Next, effects of the third example embodiment will be described. The server 31 receives, from the terminal device 33, information of the checkout target product acquired by the operation of the customer in the terminal device 33. Then, the server 31 deletes the received information on the checkout target product from the shopping list. As a result, in the self-scan shopping, the customer can delete the information of the product to be purchased from the shopping list without an additional operation. Therefore, convenience can be improved.

In the block diagram of the third example embodiment, for ease of description, all the functional units of the second example embodiment are included, but the present invention is not limited thereto. The block diagram of the third example embodiment may not include some functional units as in the second example embodiment, for example. The block diagram of the third example embodiment may include, for example, a functional unit (not illustrated). A modification of the third example embodiment will be described below.

### First Modification of Third Example Embodiment

In a case where the quantity is registered in the shopping list, the update unit 315 may further update the shopping list by comparing the quantity of the shopping list with the quantity of products to be settled. For example, in a case where the received quantity of products to be checked out is the same as the quantity registered in the shopping list, the update unit 315 may delete the received information on the products to be checked out from the shopping list. In a case where the received quantity of products to be settled is different from the quantity registered in the shopping list, the update unit 315 does not delete the received information of the products to be settled from the shopping list.

Alternatively, when the quantity of the received products to be checked out is equal to or larger than the quantity registered in the shopping list, the update unit 315 may delete the information on the received products to be checked out from the shopping list. When the received quantity of products to be settled is less than the quantity registered in the shopping list, the update unit 315 does not delete the received information of the products to be settled from the shopping list.

As described above, in a case where the quantity of products to be checked out does not satisfy the quantity of products in the shopping list, the shopping list may not be updated as the pickup has failed. In a case where the quantity of products on the shopping list satisfies the quantity of products on the shopping list, the shopping list may be updated as being successfully picked up.

In a case where the quantity of products to be checked out does not satisfy the quantity of products on the shopping list, the update unit 315 may subtract the quantity of products to be checked out from the quantity relevant to the received information on the products to be checked out from the shopping list. As a result, it is possible to prevent the information of the product from being deleted from the shopping list until the customer satisfies the necessary quantity.

The description of each example embodiment is ended.

(Computer Device)

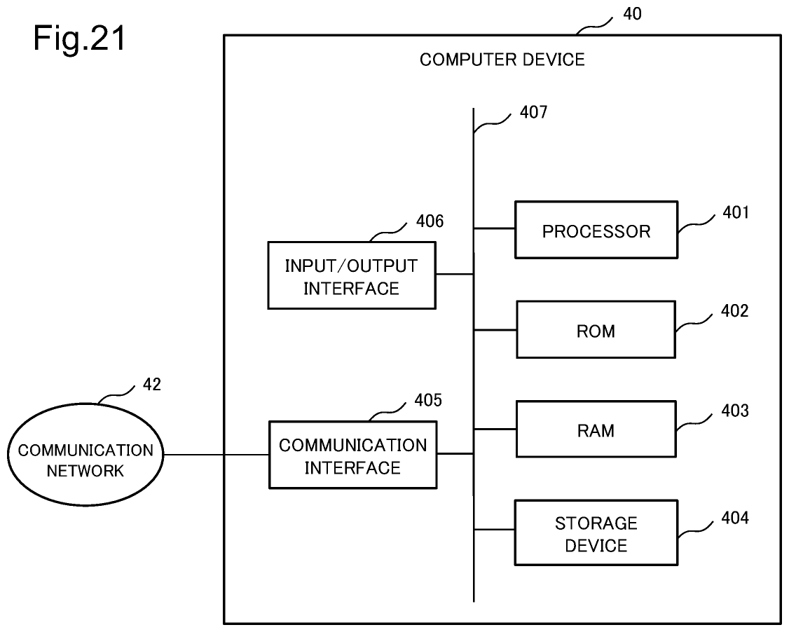

Next, a hardware configuration example in a case where each device is achieved by a computer device will be described. FIG. 21 is an explanatory diagram illustrating a hardware configuration example of a computer device. Some or all of the components of the digital signages 20 and 30, the servers 21 and 31 described in the second and third example embodiments, and the terminal device 33 described in the third example embodiment can be implemented by using, for example, an arbitrary combination of a computer device (information processing apparatus) 40 and a program as illustrated in FIG. 21.

The computer device 40 includes, for example, a processor 401, a ROM 402, a RAM 403, a storage device 404, a communication interface 405, and an input/output interface 406. The components are connected via a bus 407.

The processor 401 controls the entire computer device 40. Examples of the processor 401 include a central processing unit (CPU), a digital signal processor (DSP), and the like. The computer device 40 includes a ROM 402, a RAM 403, a storage device 404, and the like as storage units. Examples of the storage device 404 include a semiconductor memory such as a flash memory, an HDD, and an SSD. For example, the storage device 404 stores an operating system (OS) program, an application program, and the like. Alternatively, the ROM 402 stores an application program. Then, the RAM 403 is used as a work area of the processor 401.

The processor 401 loads a program stored in the storage device 404, the ROM 402, or the like. Then, the processor 401 executes each process coded in the program. The processor 401 may download various programs via the communication network 42. The processor 401 functions as a part or all of the computer device 40. Then, the processor 401 may execute processing or instructions in the illustrated flowchart based on the program.

The communication interface 405 is connected to a communication network 42 such as a local area network (LAN) or a wide area network (WAN) through a wireless or wired communication line. As a result, the computer device 40 is connected to an external device or an external computer via the communication network 42. The communication interface 405 manages an interface between the communication network 42 and the inside of the computer device 40. Then, the communication interface 405 controls input and output of data from an external device or the external computer.

The input/output interface 406 is connected to at least one of an input device, an output device, and an input/output device. The connection method may be wireless or wired. Examples of the input device include a keyboard, a mouse, and a microphone. Examples of the output device include a display device, a lighting device, and a speaker that outputs voice. Examples of the input/output device include a touch panel display. The input device, the output device, the input/output device, and the like may be built in the computer device or may be externally attached.

The hardware configuration of the computer device 40 illustrated in FIG. 21 is an example. The computer device 40 may not have some components illustrated in FIG. 21. The computer device 40 may have components other than those illustrated in FIG. 21. For example, the computer device 40 may include a camera as the imaging device. The computer device may include various sensors and the like. For example, the computer device 40 may include a drive device or the like. Then, the processor 401 may read a program or data stored in a recording medium attached to a drive device or the like into the RAM 403. Examples of the recording medium include an optical disk, a flexible disk, a magnetic optical disk, and a universal serial bus (USB) memory.

This is the end of the description of the hardware configuration example of each device. There are various modifications of the method of achieving each device. For example, the system may be achieved by an arbitrary combination of a computer and a program different for each component. A plurality of components included in each device may be achieved by any combination of one computer and a program.

A part or all of each component of the system may be achieved by an application specific circuit. A part or all of the system may be achieved by a general-purpose circuit including a processor such as a field programmable gate array (FPGA). A part or all of the system may be achieved by a combination of an application specific circuit, a general-purpose circuit, or the like. These circuits may be a single integrated circuit. Alternatively, these circuits may be divided into a plurality of integrated circuits. The plurality of integrated circuits may be configured by being connected via a bus or the like.

In a case where a part or all of each component of each device is achieved by a plurality of computers, circuits, and the like, the plurality of computers, circuits, and the like may be arranged in a centralized manner or in a distributed manner.

The method described in each example embodiment is implemented by a computer device executing the method. The method is implemented by a computer device executing a program prepared in advance. The program described in each embodiment is recorded in a computer-readable recording medium such as an HDD, an SSD, a flexible disk, an optical disk, a flexible disk, a magnetic optical disk, or a USB memory. Then, the present program is executed by being read from the recording medium by the computer. The program may be distributed via the communication network 42.

Each component of the system in each example embodiment described above may be achieved by hardware such as the computer device 40 illustrated in FIG. 21. Alternatively, each component may be achieved by a computer device or firmware based on program control.

Although the present disclosure has been particularly shown and described with reference to the present example embodiment, the present disclosure is not limited to the above example embodiment. The configuration and details of each disclosure may include example embodiments to which various changes that can be grasped by those skilled in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

A part or all of the above example embodiments can also be described as the following Supplementary Notes. However, a part or all of the above example embodiments are not limited to the following.

(Supplementary Note 1)

A system including:
an identification means configured to identify a customer;
an acquisition means configured to acquire a list including information on products to be purchased by the identified customer;
a generation means configured to generate a route from a display device to the product based on a position of the product included in the acquired list and a position of the display device; and
a display control means configured to display the generated route on the display device.

(Supplementary Note 2)

The system according to Supplementary Note 1, including:
a receiving means configured to receive selection of information of the product included in the list by an operation of the customer; and
an update means configured to delete information of the selected product from the list,
wherein
the generation means generates the route based on the updated list.

(Supplementary Note 3)

The system according to Supplementary Note 1, including:
a receiving means configured to newly receive an input of product information; and
an update means configured to add information of the received product to the list,
wherein
the generation unit generates the route based on the updated list.

(Supplementary Note 4)

The system according to Supplementary Note 1, including:
a reception means configured to receive, from a terminal device, information of a product to be checked out which acquired by an operation of the customer in the terminal device; and
an update means configured to delete the received information of the product to be checked out from the list,
wherein
the generation unit generates the route based on the updated list.

(Supplementary Note 5)

The system according to any one of Supplementary Notes 1 to 4, in which
the generation means generates the route based on an order of a distance from a position of the display device to a position of the product included in the list.

(Supplementary Note 6)

The system according to any one of Supplementary Notes 1 to 4, in which
the generation means generates the route based on an order of information of the product in the list.

(Supplementary Note 7)

The system according to any one of Supplementary Notes 1 to 4, in which
the generation means generates the route based on an order according to an attribute of the product included in the list.

(Supplementary Note 8)

The system according to Supplementary Note 7, in which
the attribute of the product is at least one of a weight of the product and a size of the product.

(Supplementary Note 9)

The system according to Supplementary Note 7, in which
the attribute of the product is at least one of frozen, refrigerated, raw, and fresh.

(Supplementary Note 10)

The system according to any one of Supplementary Notes 1 to 4, in which
the generation means generates the route based on an order according to a congestion status of a store.

(Supplementary Note 11)

The system according to any one of Supplementary Notes 1 to 4, in which
the generation means generates the route based on an order of a category to which the product in the list belongs in an order of a predetermined category of the product.

(Supplementary Note 12)

The system according to any one of Supplementary Notes 1 to 11, in which
the generation means generates a route from the display device to the product and an other product based on a position of the product included in the list, a position of the display device, and a position of the other product when there is the other product that can satisfy a discount condition by combination with the product included in the list.

(Supplementary Note 13)

The system according to any one of Supplementary Notes 1 to 12, in which
the display control means displays an entire route passing through all the products included in the list.

(Supplementary Note 14)

The system according to any of Supplementary Notes 1 to 13, including:
a voice output means configured to output a voice that guides the generated route.

(Supplementary Note 15)

The system according to any one of Supplementary Notes 1 to 14, in which
the display device is a device installed in a store.

(Supplementary Note 16)

An information processing apparatus including:
an identification means configured to identify a customer;
an acquisition means configured to acquire a list including information on products to be purchased by the identified customer;
a generation means configured to generate a route from a display device to the product based on a position of the product included in the acquired list and a position of the display device; and
a display control means configured to display the generated route on the display device.

(Supplementary Note 17)

A method including:
identifying a customer;
acquiring a list including information on products to be purchased by the identified customer;
generating a route from the display device to the product based on a position of the product included in the acquired list and a position of the display device; and
displaying the generated route on the display device.

(Supplementary Note 18)

A non-transitory computer-readable recording medium that records a program for causing a computer to execute:
identifying a customer;
acquiring a list including information on products to be purchased by the identified customer;
generating a route from the display device to the product based on a position of the product included in the acquired list and a position of the display device; and
displaying the generated route on the display device.

(Supplementary Note 19)

A program causing a computer to execute:
identifying a customer;
acquiring a list including information on products to be purchased by the identified customer;
generating a route from the display device to the product based on a position of the product included in the acquired list and a position of the display device; and
displaying the generated route on the display device.

### REFERENCE SIGNS LIST

1 system
2 system
3 system
20 digital signage
21 server
30 digital signage
31 server
33 terminal device
101 identification unit
102 acquisition unit
103 generation unit
104 display control unit
201 face feature amount acquisition unit
202 display unit
203 voice output unit
204 selection receiving unit
205 input receiving unit
211 identification unit
212 acquisition unit
213 generation unit
214 display control unit
215 update unit
301 face feature amount acquisition unit
302 display unit
303 voice output unit
304 selection receiving unit
305 input receiving unit
311 identification unit
312 acquisition unit
313 generation unit
314 display control unit
315 update unit
317 reception unit
318 registration unit
321 product information acquisition unit
322 display unit
2101 customer DB
2102 shopping list DB
2103 product DB
3101 customer DB
3102 shopping list DB
3103 product DB
3104 purchase product list DB

What is claimed is:

1. A system comprising:
a memory storing instructions; and
one or more processors configured to execute the instructions to:
identify a customer;
acquire a list including information on products to be purchased by the identified customer;
generate a route from a display device to the product based on a position of the product included in the acquired list and a position of the display device; and
display the generated route on the display device.

2. The system according to claim 1, wherein
the one or more processors are further configured to execute the instructions to:
receive selection of information of the product included in the list by an operation of the customer;
delete information of the selected product from the list; and
generate the route based on the updated list.

3. The system according to claim 1, wherein
the one or more processors are further configured to execute the instructions to:
newly receive an input of product information;
an update means configured to add information of the received product to the list; and
generate the route based on the updated list.

4. The system according to claim 1, wherein
the one or more processors are further configured to execute the instructions to:
receive, from a terminal device, information of a product to be checked out which acquired by an operation of the customer in the terminal device; and
delete the received information of the product to be checked out from the list; and
generate the route based on the updated list.

5. The system according to claim 1, wherein
the one or more processors are further configured to execute the instructions to:
generate the route based on an order of a distance from a position of the display device to a position of the product included in the list.

6. The system according to claim 1, wherein
the one or more processors are further configured to execute the instructions to:
generate the route based on an order of information of the product added to the list.

7. The system according to claim 1, wherein
the one or more processors are further configured to execute the instructions to:
generate the route based on an order according to an attribute of the product included in the list.

8. The system according to claim 7, wherein
the attribute of the product is at least one of a weight of the product and a size of the product.

9. The system according to claim 7, wherein
the attribute of the product is at least one of frozen, refrigerated, raw, and fresh.

10. The system according to claim 1, wherein
the one or more processors are further configured to execute the instructions to:
generate the route based on an order according to a congestion status of a store.

11. The system according to claim 1, wherein
the one or more processors are further configured to execute the instructions to:
generate the route based on an order of a category to which the product in the list belongs in an order of a predetermined category of the product.

12. The system according to claim 1, wherein
the one or more processors are further configured to execute the instructions to:
generate a route from the display device to the product and an other product based on a position of the product included in the list, a position of the display device, and a position of the other product when there is the other product that can satisfy a discount condition by combination with the product included in the list.

13. The system according to claim 1, wherein
the one or more processors are further configured to execute the instructions to:
display an entire route passing through all the products included in the list.

14. The system according to claim 1, wherein
the one or more processors are further configured to execute the instructions to:
output a voice that guides the generated route.

15. The system according to claim 1, wherein
the display device is a device fixed installed in a store.

16. (canceled)

17. A method comprising:
identifying a customer;
acquiring a list including information on products to be purchased by the identified customer;
generating a route from a display device to the product based on a position of the product included in the acquired list and a position of the display device; and
displaying the generated route on the display device.

18. A non-transitory computer-readable recording medium that records a program for causing a computer to execute:
identifying a customer;
acquiring a list including information on products to be purchased by the identified customer;
generating a route from a display device to the product based on a position of the product included in the acquired list and a position of the display device; and
displaying the generated route on the display device.

19. The system according to claim 1, wherein
the one or more processors configured to execute the instructions to:
identify the customer by face image of the customer captured by a camera installed in the display device.
